(19) United States
(12) Patent Application Publication
(10) Pub. No.: US 2014/0333421 A1
(43) Pub. Date: Nov. 13, 2014

(54) REMOTE CONTROL DEVICE, DISPLAY APPARATUS, AND METHOD FOR CONTROLLING THE REMOTE CONTROL DEVICE AND THE DISPLAY APPARATUS THEREOF

(71) Applicant: SAMSUNG ELECTRONICS CO., LTD., Suwon-si (KR)

(72) Inventors: Joon-ho PHANG, Seoul (KR); Joo-sun MOON, Seoul (KR); Do-sung JUNG, Seoul (KR); Christopher E. BANGLE, Clavesana CN (IT)

(73) Assignee: SAMSUNG ELECTRONICS CO., LTD., Suwon-si (KR)

(21) Appl. No.: 14/275,101

(22) Filed: May 12, 2014

(30) Foreign Application Priority Data
May 10, 2013 (KR) 10-2013-0053420

(51) Int. Cl. G08C 17/02

(52) U.S. Cl. CPC G08C 17/02; G08C 2201/30
USPC 340/12.54

(57) ABSTRACT

A remote control device, a display apparatus and a method for controlling the remote control device and the display apparatus thereof are provided. A remote control device for controlling a display apparatus includes a user interface configured to receive a user interaction, a first communicator configured to communicate with the display apparatus and receive an image, a display, and a controller configured to, in response to a first interaction being input through the user interface, control the display to display at least one image of a plurality of images received from the display apparatus, and in response to an object included in the at least one displayed image being selected according to a second interaction input through the user interface and a graphic user interface (GUI) being selected through the user interface, retrieve information related to the selected object, and display the information related to the selected object.

### CROSS-REFERENCE TO RELATED APPLICATION

This application claims priority from Korean Patent Application No. 10-2013-0053420, filed on May 10, 2013, in the Korean Intellectual Property Office, the disclosure of which is incorporated herein in its entirety by reference.

### BACKGROUND

1. Field

Apparatuses and methods consistent with exemplary embodiments relate to a remote control device, a display apparatus, and a method for controlling the remote control device and the display apparatus thereof, and more particularly to a remote control device, a display apparatus, and a method for controlling the remote control device and the display apparatus thereof, which can provide information related to an image that is reproduced in the display apparatus.

2. Description of the Related Art

A display device may provide various pieces of image content. For example, a display device may provide various pieces of content, such as broadcasting content, a VOD content, and photo content.

In the related art, a user may desire to confirm information related to an image which is displayed on the current display device. For example, a user may desire to confirm detailed information on an actor/actress that is currently displayed on the display device, a gallery, shopping information on clothes that the actor/actress wears, etc.

In the related art case where a user intends to confirm information related to an image being displayed, the user must change a screen of the display device to retrieve the information related to the image, or the user must retrieve the information related to the image through direct input of a keyword.

In this related art case, a part or the whole of the image provided on the display screen may be hidden by the information related to the image provided on the display screen. Thus, the image may be unable to be properly viewed. Further, if the user is not aware of the keyword related to the image, it may not be possible to retrieve the information related to the image.

### SUMMARY

One or more exemplary embodiments address at least the above needs and to provide at least the advantages described below. One or more exemplary embodiments provide a remote control device, a display apparatus, and a method for controlling the remote control device and the display apparatus, which can provide information related to an image that is reproduced on the display apparatus so that a user can confirm the information related to the image through the remote control device while continuously viewing the image on the display apparatus.

According to an aspect of an exemplary embodiment, there is provided a remote control device for controlling a display apparatus, the remote control device including a user interface configured to receive a user interaction, a first communicator configured to communicate with the display apparatus and receive an image, a display, and a controller configured to, in response to a first interaction being input through the user interface, control the display to display at least one image of a plurality of images received from the display apparatus, and in response to an object included in the at least one displayed image being selected according to a second interaction input through the user interface and a graphic user interface (GUI) element being selected through the user interface, retrieve information related to the selected object, and display the information related to the selected object.

In response to the first interaction being input through the user interface, the controller may be further configured to control the first communicator to receive a plurality of image frames, which are displayed by the display apparatus, with a predetermined interval from a predetermined previous point of time before the first interaction is input to a point of time when the first interaction is input.

The controller may be further configured to control the display to display the received image frames with the predetermined interval on the display, and in response to one of the displayed image frames with the predetermined interval being selected, display the GUI for selecting the information related to the selected object included in the selected image frame.

The GUI element may include at least one of an icon for providing information on a character or a person included in the selected image frame, an icon for providing different photo content of the character or the person included in the selected image frame, an icon for providing information on a product included in the selected image frame, and an icon for providing detailed information on image content including the selected image frame.

The remote control device may further include a second communicator configured to communicate with an external server, and wherein the controller may be further configured to, in response to the object included in the at least one displayed image being selected according to the second interaction, control the second communicator to receive the information related to the selected object from the external server.

The controller may be further configured to control the first communicator to receive metadata of the image together with the image, and control the second communicator to transmit the metadata to the external server and receive information on the metadata from the external server.

The controller may be further configured to control the first communicator to transmit the information related to the selected object to the display apparatus, and the display apparatus may be further configured to display the information related to the selected object.

In response to the information related to the object being received from the remote control device, the display apparatus may be further configured to generate a plurality of screens, display the image on one screen of the plurality of screens, and display the information related to the selected object on another screen of the plurality of screens.

According to an aspect of another exemplary embodiment, there is provided a method for controlling a display apparatus of a remote control device, the method including in response to a first interaction being input in a user interface, display at least one image from among a plurality of images received from the display apparatus, and in response to an object included in the at least one displayed image being selected according to a second interaction input in the user interface and a graphic user interface (GUI) element being selected through the user interface, retrieving and displaying information related to the selected object.

In response to the first interaction being input, displaying the at least one image includes receiving a plurality of image frames, which are displayed by the display apparatus, with a predetermined interval from a predetermined previous point of time before the first interaction is input to a point of time when the first interaction is input.

Displaying the at least one image may further include displaying the received image frames with the predetermined interval, and the retrieving and displaying the information related to the selected object includes, in response to one of the displayed image frames with the predetermined interval being selected, displaying the GUI for selecting the information related to the selected object included in the selected image frame.

The GUI element may include at least one of an icon for providing information on a character or a person included in the selected image frame, an icon for providing different photo content for the character or the person included in the selected image frame, an icon for providing information on a product included in the selected image frame, and an icon for providing detailed information on image content including the selected image frame.

In response to the retrieving and displaying the information related to the selected object includes, in response to the object included in the at least one displayed image being selected according to the second interaction, receiving the information related to the selected object from an external server.

The receiving information related to the selected object may include receiving metadata of the image together with the image, and the retrieving and displaying the information related to the selected object may further include transmitting the metadata to the external server and receiving information on the metadata from the external server.

The method may further include transmitting the information related to the selected object to the display apparatus, and the display apparatus may display the information related to the selected object.

In response to information related to the object being received from the remote control device, the display apparatus may generate a plurality of screens, display the image on one screen of the plurality of screens, and display the information related to the selected object on another screen of the plurality of screens.

According to still another aspect of the exemplary embodiments, a display apparatus includes a communicator configured to communicate with a remote control device, a display, a storage, and a controller configured to temporarily store in the storage an image which is displayed by the display, and in response to a predetermined command being input from the remote control device, control the communicator to transmit the image which is temporarily stored in the storage to the remote control device.

The controller may be configured to, in response to the information related to the image being received from the remote control device, control the display to display a plurality of screens on the display, display the image on one screen of the plurality of screens, and display information related to the image on another screen of the plurality of screens.

According to an aspect of another exemplary embodiment, there is provided a method for controlling a display apparatus includes displaying an image; storing the displayed image in a storage temporarily, and in response to a predetermined command being input from a remote control device, transmitting the image which is temporarily stored in the storage to the remote control device.

The method may further include, in response to the information related to the image being received from the remote control device, displaying a plurality of screens on the display, displaying the image on one screen of the plurality of screens, and displaying information related to the image on another screen of the plurality of screens.

According to an aspect of another exemplary embodiment, there is provided a method for controlling a remote device configured to control a display device, the method including determining whether a predetermined user interaction is input; receiving an image from a display apparatus in response to the predetermined user interaction being input; displaying the received image on a display of the display apparatus; determining whether a user command is input; and displaying information related to the received image in response to the user command being input.

### BRIEF DESCRIPTION OF THE DRAWINGS

The above and/or other aspects will be more apparent from the following detailed description of exemplary embodiments when taken in conjunction with the accompanying drawings, in which:

FIG. 1 is a view illustrating a display system according to an exemplary embodiment;

FIG. 2 is a block diagram schematically illustrating the configuration of a display apparatus according to an exemplary embodiment;

FIG. 3 is a block diagram illustrating the detailed configuration of a display apparatus according to an exemplary embodiment;

FIG. 4 is a diagram illustrating the detailed configuration of a storage according to an exemplary embodiment;

FIG. 5 is a block diagram illustrating the configuration of a remote control device according to an exemplary embodiment;

FIG. 6 is a view illustrating an external appearance of a remote control device according to an exemplary embodiment;

FIGS. 7 to 15 are views explaining operations related to OJ sensors according to an exemplary embodiment;

FIGS. 16 to 24 are views explaining operations related to bookmark buttons according to an exemplary embodiment;

FIG. 25 is a flowchart illustrating a method for controlling a remote control device for providing a bookmark service according to an exemplary embodiment;

FIG. 26 is a sequential diagram explaining a method for controlling a display system for providing a bookmark service according to an exemplary embodiment;

FIG. 27 is a flowchart illustrating a method for controlling a display apparatus for providing an indicator when a user command is inputted to an OJ sensor; and

FIG. 28 is a view illustrating an indicator indicating movement of a remote control device according to another exemplary embodiment.

### DETAILED DESCRIPTION OF THE EXEMPLARY EMBODIMENTS

Hereinafter, embodiments of the present disclosure are described in detail with reference to the accompanying drawings.

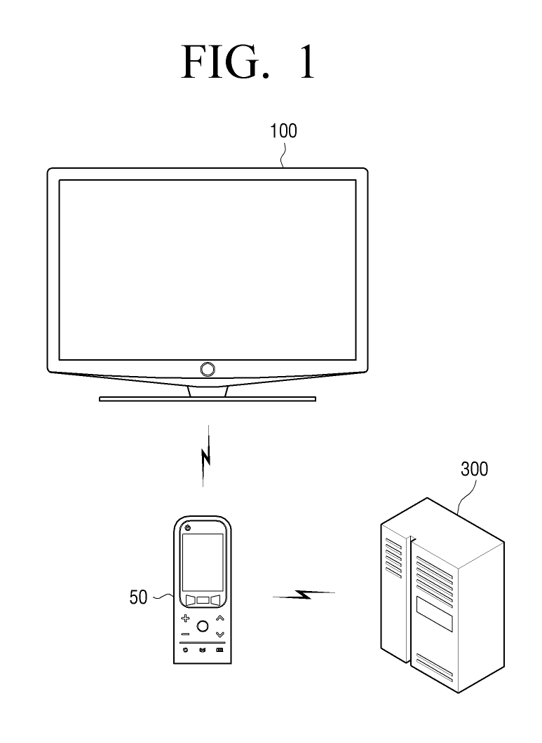

FIG. 1 is a view illustrating a display system according to an exemplary embodiment. Referring to FIG. 1, a display system 10 according to an exemplary embodiment includes a display apparatus 100, a remote control device 50, and an information providing server 300.

As illustrated in FIG. 1, the display apparatus 100 may be implemented as a digital TV, but is not limited thereto. The display apparatus 100 may be implemented by various types of devices having display functions, such as a PC, a mobile phone, a tablet personal computer (PC), a PMP, a PDA, and navigation. On the other hand, if the display apparatus 100 is implemented by a portable device, it has a touch screen built therein, and may execute a program using a finger or a pen (e.g., stylus pen). Hereinafter, for convenience, explanation will be made on the assumption that the display apparatus 100 is implemented by a digital TV.

The display apparatus 100 may display a plurality of screens for reproducing plural pieces of content on one display screen according to a user interaction input to the remote control device 50. The plural pieces of content may include at least one of a broadcasting content, a video on demand (VOD) content, and photo content. However, exemplary embodiments are not limited, and other various types of contents may be reproduced on the display apparatus 100. Further, the display apparatus 100 may provide various UIs according to user interactions input to the remote control device 50.

If the display apparatus 100 is implemented by a digital TV, the display apparatus 100 may be controlled by the remote control device 50. In this case, the remote control device 50 is a device for remotely controlling the display apparatus 100, and may receive a user command and transmit a control signal corresponding to the input user command to the display apparatus 100. For example, the remote control device 50 may be implemented in various forms, such as sensing movement of the remote control device 50 and transmitting a signal corresponding to the movement, recognizing voice and transmitting a signal corresponding to the recognized voice, or transmitting a signal corresponding to an input key. In this case, the remote control device 50 may be implemented by including a motion sensor, a touch sensor or an optical joystick (OJ) sensor applying an optical technology, a physical button (e.g., tack switch), a display screen, and a microphone to receive an input of various types of user commands. The OJ sensor is an image sensor that senses a user operation through an OJ, and operates as a reversed optical mouse. In other words, if a user slightly touches the OJ with a finger, the OJ sensor may analyze an optical signal. On the other hand, the remote control device 50 according to an exemplary embodiment may be implemented by a remote controller. However, this is merely exemplary, and the remote control device 50 may be implemented by various types of portable devices, such as a smart phone or a tablet PC that can control the display apparatus 100.

Further, if a predetermined user interaction is input from the remote control device 50, the display apparatus 100 may transmit an image which is currently displayed to the remote control device 50. Further, the remote control device 50 displays the received image, receives information related to the image from an external information retrieval server 300 according to a user command, and displays the information related to the received image. While the information is retrieved using the remote control device 50, the display apparatus 100 may continuously display the image. Therefore, a user can retrieve the information related to the image using the remote control device 50 while continuously viewing the image through the display apparatus 100. A bookmark service to provide the information related to the image that is currently being displayed using the remote control device 50 will be described later.

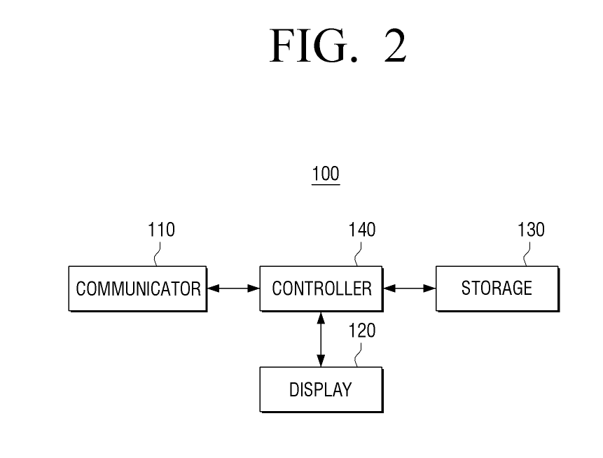

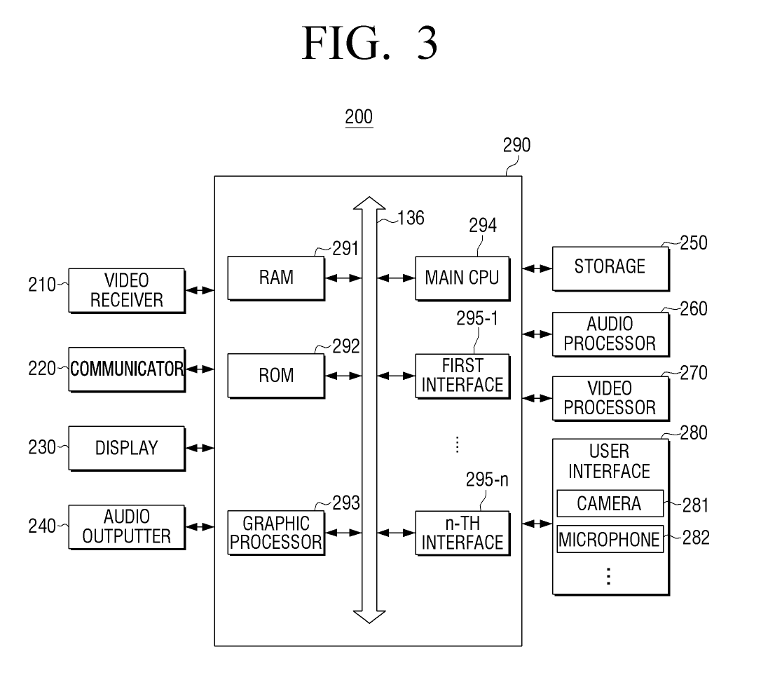

FIGS. 2 and 3 are block diagrams illustrating the configuration of a display apparatus according to an exemplary embodiment.

Referring to FIG. 2, the display apparatus 100 includes a communicator 110, a display 120, a storage 130, and a controller 140.

The communicator 110 performs communication with an external device. In particular, the communicator 110 may receive an input of a user interaction for controlling the display apparatus 100 from the remote control device 50. In particular, the communicator 110 may receive an input of a user interaction (hereinafter, “bookmark interaction”) for receiving a bookmark service from the remote control device 50.

Further, the communicator 110 may transmit the image that is currently being displayed to the remote control device 50 in response to the bookmark interaction. In particular, the communicator 110 may transmit an image frame (e.g., “I frame”) to the remote control device 50 with a predetermined interval, among displayed image frames, from a predetermined previous point of time before the bookmark interaction is input to a point of time when the bookmark interaction is input. At this time, the communicator 110 may transmit metadata of the image together with the image frames of the currently displayed image. In this case, the metadata includes information on the image frame. The information on the image frame may include character information included in the current image frame and commodity information. However, exemplary embodiments are not limited. In another exemplary embodiment, the predetermined interval may include a point of time from when the bookmark interaction is input to a point of time after the bookmark interaction is input. Further, the predetermined interval may include a period of time before the bookmark interaction is input to a same period of time after the bookmark interaction is input.

Further, the communicator 110 may receive the information related to the currently displayed image and the user command to display the information related to the image from the remote control device 50.

The display 120 outputs image data that is received from an external source, pre-stored, or a user interface (UI) under the control of the controller 130. In particular, the display 120 may display a plurality of screens for reproducing plural pieces of content on one display screen according to the user predetermined command. In this case, the plurality of screens can be overlapped in a preset shape (i.e., rectangle, trapezoid, etc.) or disposed separately on one display screen. In particular, the plurality of screens can be disposed to have a different viewing angle. As an example, when a user viewing angle changes, location of the plurality of screens can move in accordance with the changed viewing angle. In this case, a 2D image can be displayed on each of the plurality of screens, but this is merely exemplary, and a 3D image can be displayed on each of the plurality of screens.

According to an exemplary embodiment, the display 120 may display a main screen in the center area of the display screen and display a first sub-screen and a second sub-screen in the form of a trapezoid on the left and right sides of the main screen. As described above, since the first sub-screen and the second sub-screen are arranged on the left and right sides of the main screen in the form of a trapezoid, a user can feel an effect as if the user viewed the main screen, the first sub-screen, and the second sub-screen in a 3D space. However, this is merely exemplary, and the sub-screens may be displayed in upper and lower directions or in diagonal directions of the main screen, and three or more sub-screens may be displayed. Hereinafter, for convenience, explanation will be made on the assumption that the sub-screens are arranged on the left and right sides of the main screen.

The main screen is a screen for displaying content that the user mainly views, and has the highest occupation ratio on the display screen. In particular, audio of the main screen may be output with the highest level of the display apparatus 100.

The sub-screens are screens for displaying content that a user desires to retrieve in addition to the main screen, and may have a lower occupation ratio than the occupation ratio of the main screen on the display screen. In particular, the sub-screen may display only a part of the content screen being reproduced. Further, the audio of the sub-screen may not be output or may be output with a level that is lower than a predetermined level value according to the occupation ratio of the sub-screen on the display screen.

Further, the main screen and the sub-screen may move according to predetermined user interactions to cause at least one of the position, size, and shape thereof to be changed, and the main screen and the sub-screen may be changed to each other. For example, if the predetermined user interaction is a user head rotation interaction, the controller 140 senses the rotation of the user head, and may control the display 120 to move the main screen, the first sub-screen, and the second sub-screen according to the sensed rotation direction of the user head. Further, the controller 140 may set the sub-screen as a new main screen if the rotating angle of the user head is sensed with a level which is higher than a predetermined level. In another exemplary embodiment, the controller 140 may sense an eye movement of the user, and may control the display 120 to move the main screen, the first sub-screen, and the second sub-screen according to the sensed eye movement of the user.

Further, if the information related to the currently displayed image is displayed from the remote control device 50, the display 120 may display the information related to the currently displayed image. In particular, the display 120 may display the image on the main screen among the plurality of screens, and display the information related to the image on the second sub-screen among the plurality of screens.

On the other hand, the display 120 may be implemented by an Liquid Crystal Display (LCD) panel or Organic Light emitting Diodes (OLED). However, the display 120 is not limited thereto. Further, the display 120 may also be implemented by a flexible display or a transparent display.

The storage 130 stores various data for driving the display apparatus 100. In particular, the storage 130 may temporarily store the currently displayed image (e.g., broadcasting image) for a predetermined time. For example, the storage 130 may temporarily store the image frame of the image which is displayed on the display 120 for 10 seconds. Further, the storage 130 may temporarily store the image frame in a First In First Out (FIFO) manner.

On the other hand, the storage 130 may be implemented by various storage media, such as a ROM, a RAM, and a hard disk.

The controller 140 controls the whole operation of the display apparatus 100 according to a user command input through the remote control device 50. In particular, if a bookmark interaction is input from the remote control device 50 while the image that is displayed on the display 120 is temporarily stored in the storage 130, the controller 140 may control the communicator 110 to transmit the image that is temporarily stored in the storage 130 to the remote control device 50. At this time, the controller 140 may control the communicator 110 to transmit the image frame (e.g., I frame) to the remote control device 50 with a predetermined interval, among the image frames that are temporarily stored in the storage 130.

Further, if the information related to the currently displayed image is received from the remote control device 50, the controller 140 may control the display 120 to display the information related to the currently displayed image (or information related to an object included in the image). In particular, the controller 140 may control the display 120 to display the image on the main screen and to display the information related to the image on the second sub-screen among the plurality of screens. In another exemplary embodiment, the controller 140 may control the display 120 to display both the image and the information related to the image on the main screen.

FIG. 3 is a block diagram illustrating the detailed configuration of the display apparatus according to an exemplary embodiment. As illustrated in FIG. 3, the display apparatus 200 according to an exemplary embodiment includes an image receiver 210, a communicator 220, a display 230, an audio outputter 240, a storage 250, an audio processor 260, a video processor 270, a user interface 280, and a controller 290.

The image receiver 210 receives image data through various sources. For example, the image receiver 210 may receive broadcasting data from an external broadcasting station, may receive image data from an external device (e.g., a DVD or a BD player), and may receive image data stored in the storage 250. In particular, the image receiver 210 may be provided with a plurality of image reception modules to display a plurality of screens on one display screen. For example, the image receiver 210 may be provided with a plurality of tuners to simultaneously display a plurality of broadcasting channels.

The communicator 220 is configured to perform communication with various types of external devices or an external server in accordance with various types of communication methods. The communicator 220 may include various communication chips, such as a Wi-Fi chip, a Bluetooth chip, a Near Field Communication (NFC) chip, and a wireless communication chip. In this case, the Wi-Fi chip, the Bluetooth chip, and the NFC chip perform communication in a Wi-Fi method, Bluetooth method, and NFC method, respectively. Among them, the NFC chip means a chip that operates in an NFC method that uses a 13.56 MHz band among various RF-ID frequency bands, such as 135 kHz, 13.56 MHz, 433 MHz, 860 to 960 MHz, and 2.45 GHz. In the case of using a Wi-Fi chip or a Bluetooth chip, various kinds of connection information, such as SSID and session keys, may be first transmitted or received, and using these, various kinds of information may be transmitted or received after the communication is connected. A wireless communication chip means a chip that performs communication according to various communication standards, such as IEEE, Zigbee, 3^{rd} Generation (3G), 3^{rd} Generation Partnership Project (3GPP), and Long Term Evolution (LTE).

In particular, the communicator 220 may perform communication with the remote control device 50. In particular, the communicator 220 may receive an input of a user interaction for controlling the display apparatus 200 from the remote control device 50. In particular, the communicator 220 may receive an input of a bookmark interaction for receiving a bookmark service. Further, the communicator 220 may transmit image frames that are temporarily stored in the storage 250 to the remote control device 50 in response to the bookmark interaction. On the other hand, the communicator 220 may perform communication with the remote control device 50 using a Bluetooth interface.

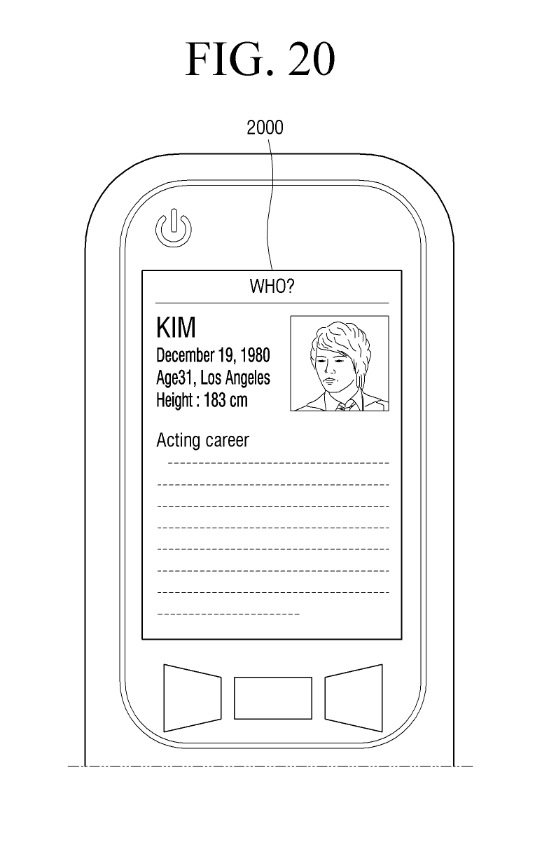

The display 230 displays at least one of video frames obtained by processing the image data received by the image receiver 210 through the video processor 270 and various screens generated by the graphic processor 293. In particular, the display 230 may display a plurality of screens for reproducing plural pieces of content on one display screen according to the user predetermined command. For example, as illustrated in FIG. 20, the display 230 may display the main screen in the center area of the display screen and may display the first sub-screen and the second sub-screen in the form of a trapezoid on the left and right sides of the main screen.

The audio outputter 240 is configured to output various kinds of notification sounds or voice messages in addition to various kinds of audio data processed by the audio processor 260. In particular, the audio outputter 240 may be implemented by a speaker. However, this is merely exemplary, and the audio outputter 240 may be implemented by another audio outputter, such as an audio output terminal.

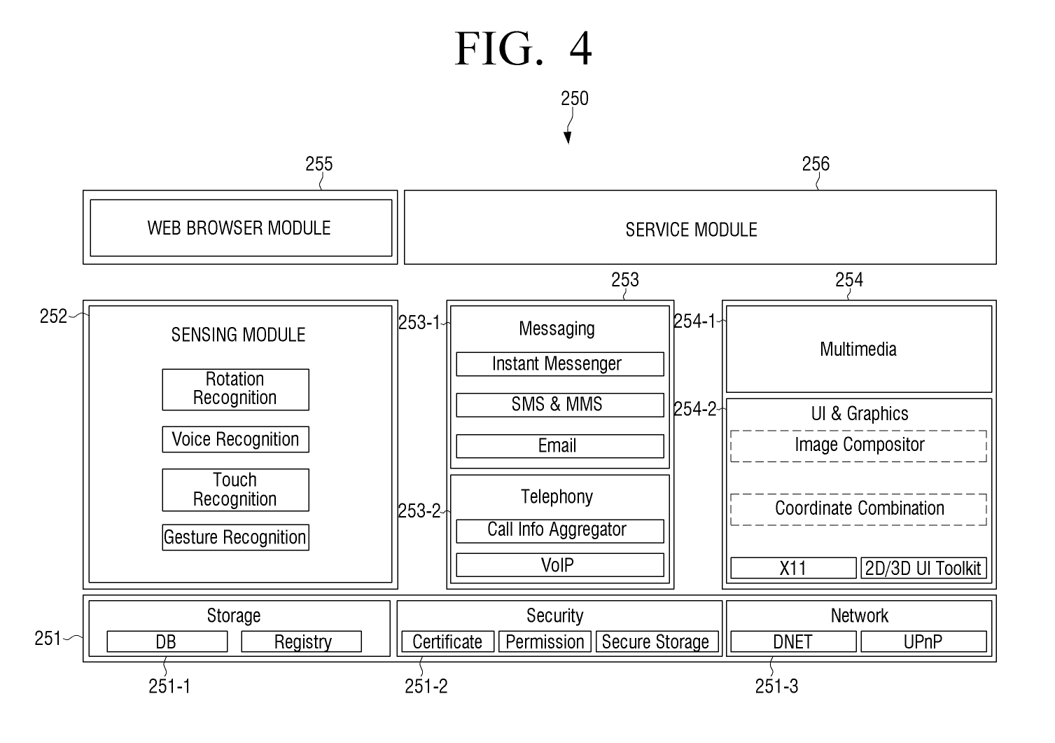

The storage 250 stores various modules for driving the display apparatus. In particular, the configuration of the storage 250 will be described with reference to FIG. 4.

FIG. 4 is a diagram illustrating a software configuration stored in the storage 250.

Referring to FIG. 4, in the storage 250, software that includes a base module 251, a sensing module 252, a communication module 253, a presentation module 254, a web browser module 255, and a service module 256 may be stored.

The base module 251 means a basic module which processes signals transferred from hardware included in the user terminal apparatus 100 and transfers the processed signals to an upper-layer module. The base module 251 includes a storage module 251-1, a secure module 251-2, and a network module 251-3. The storage module 251-1 is a program module that manages a database DB or registries. The main CPU 294 may read various kinds of data by accessing the database in the storage 250 using the storage module 251-1. The secure module 251-2 is a program module that supports hardware certification, request permission, and secure storage, and the network module 251-3 includes a modulo DNET module and an UPnP module for supporting network connection.

The sensing module 252 is a module which collects information from various kinds of sensors, analyzes, and manages the collected information. The sensing module 252 may include a face recognition module, a voice recognition module, a motion recognition module, and an NFC recognition module.

The communication module 253 is a module for performing communication with an external source. The communication module 253 may include a messaging module 253-1, such as a messenger program, an SMS (Short Message Service) & MMS (Multimedia Message Service) program, and an e-mail program, and a phone module 253-2 including a call information aggregator program module and a VoIP module.

The presentation module 254 is a module for configuring a display screen. The presentation module 254 includes a multimedia module 254-1 for reproducing and outputting multimedia content, and a UI rendering module 254-2 performing UI and graphic processing. The multimedia module 254-1 may include a player module, a camcorder module, and a sound processing module. Accordingly, the multimedia module reproduces various kinds of multimedia content to generate and reproduce the screen and sound. The UI rendering module 254-2 may include an image compositor module combining images, a coordinate combination module combining and generating coordinates on the screen on which an image is to be displayed, an X11 module receiving various kinds of events from hardware, and a 2D/3D UI tool kit providing a tool for configuring 2D or 3D type UI.

The web browser module 255 may be a module that accesses a web server by performing web browsing. The web browser module 255 may include various modules, such as a web view module configuring a web page, a download agent module performing a download, a bookmark module, and a web kit module.

The service module 256 is a module including various kinds of applications for providing various services. In particular, the service module 256 may include various program modules, such as a social network service (SNS) program, a content reproduction program, a game program, an electronic book program, a calendar program, an alarm management program, and other widgets.

Although FIG. 4 illustrates various program modules, the illustrated program modules can be partially omitted, modified, or added depending on the kind and characteristic of the user terminal apparatus 200. For example, a position based module, which support a position based service in association with the hardware such as the global positioning system (GPS) chip, may be further implemented.

Further, the storage 250 may include a buffer (not illustrated) that temporarily stores the currently displayed image. In particular, when a broadcasting image is received from an outside and is displayed, the storage 250 may temporarily store the broadcasting image frame that is received in a FIFO manner for a predetermined time (e.g., 10 seconds). At this time, the storage 250 may store only I frames among the broadcasting image frames. However, this is merely exemplary, and all the image frames may be temporarily stored for the predetermined time. Further, the storage 250 may temporarily store metadata including information on the image frames (e.g., character information, shopping information, content information, etc.) together with the image frames.

Referring again to FIG. 3, the audio processor 260 is an element that processes audio data. The audio processor 260 may perform various processes, such as decoding, amplification, and noise filtering, with respect to the audio data. On the other hand, the audio processor 26 may be provided with a plurality of audio processing module for processing audio corresponding to the plural pieces of content.

The video processor 270 is an element that processes image data that is received from the image receiver 210. The video processor 280 may perform various image processes, such as decoding, scaling, noise filtering, frame rate conversion, and resolution conversion with respect to the image data. On the other hand, the video processor 270 may be provided with a plurality of video processing module for processing video corresponding to the plural pieces of content.

The user interface 280 is a configuration to sense a user interaction for controlling the whole operation of the display apparatus 200. In particular, as illustrated in FIG. 3, the user interface 280 may include various interaction sensing devices, such as a camera 281 and a microphone 282. The camera 281 is a configuration to capture a still image or a moving image under a user control. In particular, the camera 281 may capture images of various kinds of user motions. The microphone 282 is a configuration to receive the user voice or other sound, and to convert the input voice or sound into audio data. The controller 290 may use the user voice input through the microphone 282 in a call process, or may store the user voice in the storage 250.

If the camera 281 and the microphone 282 are provided, the controller 290 may perform a control operation in accordance with the user voice input through the microphone 282 or a user motion recognized by the camera 281. In other words, the display apparatus 200 may operate in a motion control mode or in a voice control mode. If the display apparatus 200 operates in the motion control mode, the controller 290 captures an image of the user through activation of the camera 291, tracks the change of the user motion, and performs the corresponding control operation. If the display apparatus 200 operates in the voice control mode, the controller 290 may analyze the user voice input through the microphone, and may operate in a voice recognition mode in which a control operation is performed according to the analyzed user voice.

The controller 290 controls the whole operation of the display apparatus 200 using various kinds of programs stored in the storage 250.

As illustrated in FIG. 2, the controller 290 includes a RAM 291, a ROM 292, a graphic processor 293, a main CPU 294, first to n-th interfaces 295-1 to 295-n, and a bus 296. At this time, the RAM 291, the ROM 292, the graphic processor 293, the main CPU 294, and the first to n-th interfaces 295-1 to 295-n may be connected to each other through a bus 296.

In the ROM 132, a command set for system booting is stored. If a turn-on command is input and the power is supplied, the main CPU 294 copies the O/S stored in the storage 250 into the RAM 291 according to the command stored in the ROM 292, and boots the system by executing the O/S. If the booting is completed, the main CPU 294 copies various kinds of application programs stored in the storage 140 into the RAM 292, and performs various kinds of operations by executing the application programs copied into the RAM 291.

The graphic processor 293 creates a screen including various objects, such as icons, images, and text, using an operator (not illustrated) and a renderer (not illustrated). The operator operates attribute values, such as coordinate values, shapes, sizes, and colors, for displaying respective objects according to the layout of the screen using the control command received from the inputter 280. The renderer generates various layout screens including objects based on the attribute values operated by the operator. The screen generated by the renderer is displayed in the display area of the display 230.

The main CPU 294 accesses the storage 250, and performs booting using the O/S stored in the storage 250. Further, the main CPU 294 performs various operations using various kinds of programs, content, and data stored in the storage 250.

The first to n-th interfaces 295-1 to 295-n are connected to various kinds of constituent elements as described above. One of the interfaces may be a network interface connected to an external device through a network.

In particular, if a bookmark interaction is input from the remote control device 50, the controller 290 may transmits the image that is temporarily stored in the storage 250 to the remote control device 50 corresponding to the bookmark interaction. In particular, the controller 290 may control the communicator 210 to transmit an image frame to the remote control device 50 with a predetermined interval, among image frames which are displayed on the display 230, from a predetermined previous point of time before the bookmark interaction is input to a point of time when the bookmark interaction is input. For example, in response to the bookmark interaction, the controller 290 may control the communicator 210 to extract the image frame of I-frame, among the image frames that are displayed on the display 230 before 10 seconds from the point of time when the bookmark interaction is input to the point of time when the bookmark interaction is input, and to transmit the 10 image frames to the remote control device 50. In this case, the controller 290 may control the communicator 210 to make the image frame with the predetermined interval displayed by the remote control device 50, and transmit it to the remote control device 50. In another exemplary embodiment, the predetermined interval may include a point of time from when the bookmark interaction is input to a point of time after the bookmark interaction is input. Further, the predetermined interval may include a period of time before the bookmark interaction is input to a same period of time after the bookmark interaction is input.

In particular, while the image frames are transmitted with the predetermined interval, the controller 290 may control the communicator 210 to transmit the metadata for storing the information on the image frame to the remote control device 50. In this case, the information on the image frame may include reproduction information of the corresponding image frame, information on a character belonging to the image frame, and information on a commodity (e.g., shopping information) included in the image frame. As described above, the remote control device 50 may retrieve the information related to the image using the transmitted image frame and the metadata.

In the above-described exemplary embodiment, it has been explained that the communicator 210 transmits metadata along with the image frame. However, this is merely an exemplary embodiment. Metadata can be transmitted by a user command before or after transmitting the image frame.

Further, if the information related to the image and the user command for displaying the information related to the image are input from the remote control device 50, the controller 290 may display the information related to the image on the display 230. At this time, the controller 290 may control the display 230 to display the information related to the image while keeping the currently displayed image. For example, if the information related to the image and the user command for displaying the information related to the image are input while the image is displayed, the controller 290 may generate a plurality of screens on the current display screen, display the image on the main screen among the plurality of screens, and retrieve the information related to the image on the second sub-screen positioned on the right side of the main screen. In another exemplary embodiment, the information related to the image may be displayed on the main screen with the image.

As described above, by retrieving the information related to the currently display image using the remote control device 50, the user can confirm the information related to the image using the remote control device 50 or another screen of the display screen while continuously viewing the currently displayed image.

Further, the controller 290 may control the display apparatus 200 according to the user input to the OJ sensor provided on the remote control device 50.

If a rubbing interaction to rub the OJ sensor provided on the remote control device 50 is input, the controller 290 may move a highlight which is displayed on one of a plurality of icons to another icon according to the direction of the rubbing interaction. For example, if a rubbing interaction in the left direction while a highlight is displayed on one of the plurality of icons, the controller 290 may move the highlight to the icon that is positioned on the left side of the icon on which the highlight is currently displayed.

Further, if a push interaction to push the OJ sensor is input, the controller 290 determines the time when the OJ sensor is pushed. In particular, if the OJ sensor pushing time is shorter than a predetermined time, the controller 290 may determine that the push interaction is an enter command, and may select the icon on which the highlight is displayed. However, if the OJ sensor pushing time is longer than the predetermined time, the controller 290 may determine that the push interaction is a trigger command for starting determination of the movement of the remote control device 50, and may control the display 230 to display an indicator that indicates the movement of the remote control device 50 on the display screen. The method for controlling the display apparatus 200 according to the user input to the OJ sensor will be described later with reference to the drawings.

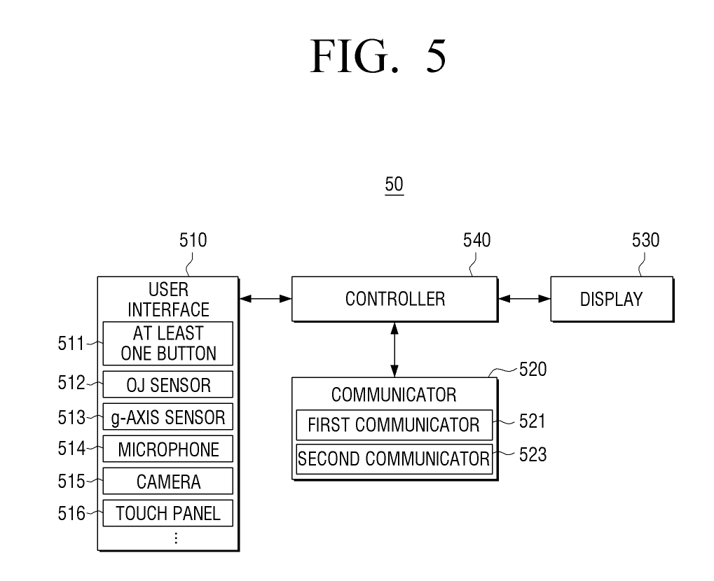

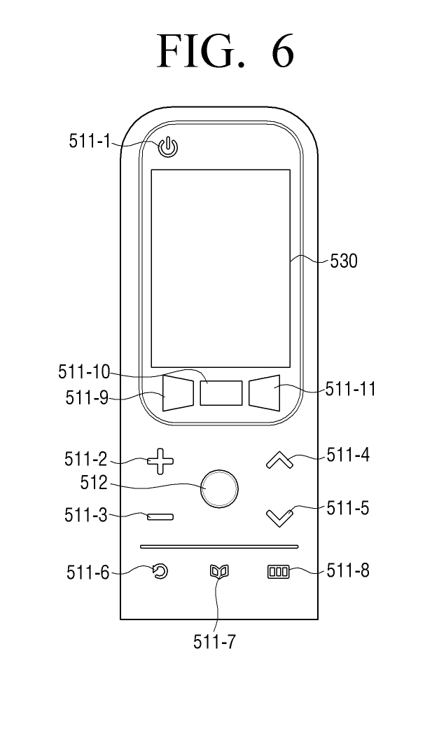

Hereinafter, referring to FIGS. 5 and 6, the remote control device 50 will be described in more detail.

FIG. 5 is a block diagram illustrating the configuration of the remote control device 50 according to an exemplary embodiment. As illustrated in FIG. 5, the remote control device 50 includes a user interface 510, a communicator 520, a display 530, and a controller 540.

FIG. 5 illustrates various kinds of elements in the case where the remote control device 50 is a device having various functions, such as a communication function and a display function. Thus, in accordance with the embodiments, a part of the elements illustrated in FIG. 5 may be omitted or changed, or other elements may be added thereto.

The user interface 510 receives various user interactions for controlling the display apparatus 200 or the remote control device 50. In particular, as illustrated in FIG. 5, the user interface 510 may include at least one button 511, an OJ sensor 512, a 9-axis sensor 513, a microphone 514, a camera 515, and a touch panel 516.

As illustrated in FIG. 6, the at least one button 511 includes a power button 511-1, volume control buttons 511-2 and 511-3, channel change buttons 511-4 and 511-5, a previous button 511-6, a bookmark button 511-7, a menu button 511-8, and screen designation buttons 511-9, 511-10, and 511-11. The power button 511-1 may receive a user command for turning on/off the power of the display apparatus 200. The volume control buttons 511-2 and 511-3 may receive a user command for adjusting volume output from the display apparatus 200. The channel change buttons 511-4 and 511-5 may receive a user command for changing a broadcasting channel output from the display apparatus 200. The previous button 511-6 may receive a user command for the display apparatus 200 to move to the previous display state. The bookmark button 511-7 may receive a user command for providing a bookmark service. The menu button 511-8 may receive a user command for generating a menu. The screen designation buttons 511-9, 511-10, and 511-11 may designate a screen on which the content that corresponds to the current highlighted icon is to be displayed. In particular, the shapes of the screen designation buttons 511-9, 511-10, and 511-11 may be equal to the shape of the main screen 2320, the first sub-screen 2310, and the second sub-screen 2330 illustrated in FIG. 20. However, exemplary embodiments of the user interface 510 are not limited to the at least one button 511. In another exemplary embodiment, the user commands may be input via a touch screen on the user interface 510. In this exemplary embodiment, the user commands may be input by a user using at least one icon or at least one virtual button on the touch screen.

The OJ (Optical Joystick) sensor 512 senses a rubbing interaction or a push interaction. In particular, if a rubbing interaction to rub the OJ sensor 512 with a finger is inputted, the OJ sensor 512 transfers image data of a finger surface that is obtained by irradiating infrared (IR) of an IR-LED which is a colorless light source thereon to an image sensor having a DSP function through a nano optical module, and senses the moving direction of the user finger that is output from the image sensor. In accordance with the moving direction of the user finger input to the OJ sensor, the display apparatus 200 may move the highlight displayed on the icon to another icon.

Further, if a push interaction to push the OJ sensor 512 is input, the controller 540 may determine whether the push interaction is an enter command or a trigger command to determine the movement of the remote control device 50 through determination of the time when the push interaction is performed. If the push interaction performing time is shorter than the predetermined time, the controller 540 may determine that the push interaction is the enter command, and if the push interaction performing time is longer than the predetermined time, the controller may determine that the push interaction is the trigger command to start the determination of the movement of the remote control device 50.

The 9-axis sensor 513 may determine a 3D movement of the remote control device 50. In particular, the 9-axis sensor 513 may determine the movement of the remote control device 50 in a 3D space using a gyro sensor, an acceleration sensor, and a geomagnetic sensor.

The microphone 514 is a configuration to receive an input of a user voice or other sound and to convert the received voice or sound into audio data. The controller 540 may use the user voice input through the microphone 514 in a call process, or convert the user voice into audio data to use the audio data as a control command.

The camera 515 is a configuration to capture a still image or a moving image according to the user control. In particular, the camera 515 may capture an image of a user motion for controlling the remote control device 50 or the display apparatus 200.

The touch panel 516 may be provided on the display 530 to sense the user touch input.

The communicator 520 may perform communication with an external device. In particular, the communicator 520 may include a first communicator 521 to perform communication with the display apparatus 200 and a second communicator 522 to perform communication with an external information retrieval server 300.

The first communicator 521 may transmit a user interaction for controlling the display apparatus 200. In particular, if a bookmark button 511-7 is selected, the first communicator 521 may transmit the bookmark interaction to the display apparatus 200, and may receive an image and metadata in response to the bookmark interaction from the display apparatus 200.

Further, if one of the screen designation buttons 511-9, 511-10, and 511-11 is selected while the information related to the image is displayed, the first communicator 521 may transmit the information related to the image and a command for displaying the information related to the image on a screen that corresponds to the selected screen designation button to the display apparatus 200.

The second communicator 522 may perform communication with the external information retrieval server 300. In particular, if an image frame to be retrieved is selected through the user input, the second communicator 522 may transmit metadata of the selected image frame to the information retrieval server 300 and may receive the information related to the image frame from the information retrieval server 300.

The first communicator 521 and the second communicator 522 may perform communication using different communication interfaces. For example, the first communicator 521 may perform communication with the display apparatus through a Bluetooth interface or a Zigbee interface, and the second communicator 522 may perform communication with the external information retrieval server 300 through a Wi-Fi interface.

The display 530 may display the image data or the UI under the control of the controller 540. In particular, the display 530 may display image frames received from the display apparatus 200. If one of image frames being displayed is selected, the display 530 may display a GUI for selecting the information related to the selected image frame. In this case, the GUI may include at least one of an icon for providing information on a character included in the selected image frame, an icon for providing other photo content of the character included in the selected image frame, an icon for providing shopping information of an article included in the selected image frame, and an icon for providing detailed information on the image content including the selected image frame.

The controller may control the remote control device 50 or the display apparatus 200 in accordance with the user command input through the user interface 510.

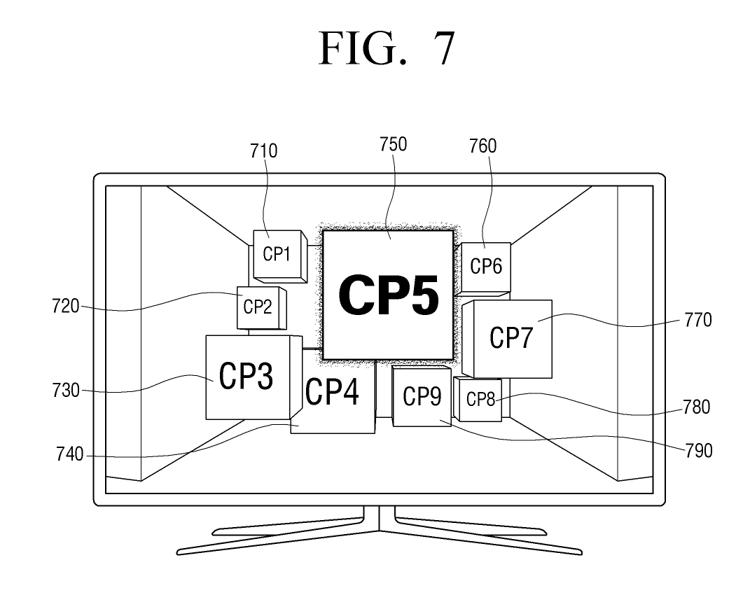

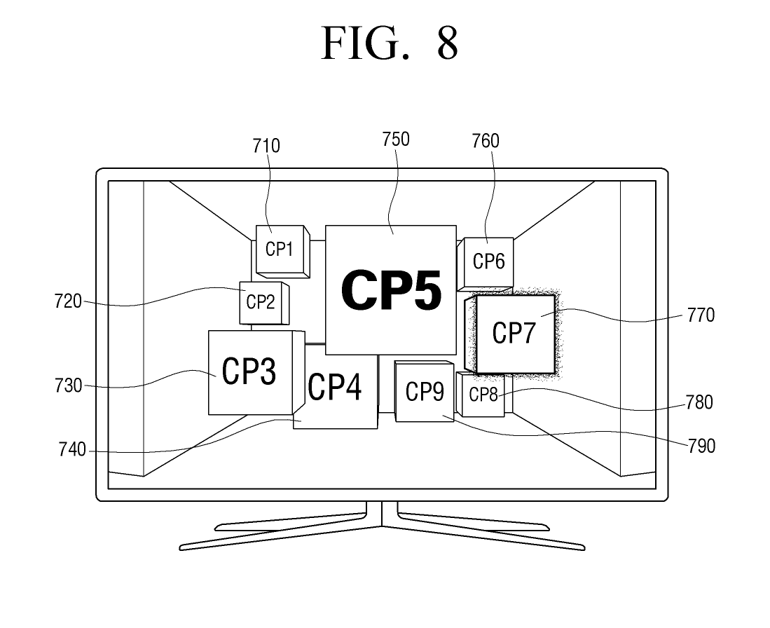

In particular, the controller 540 may control the display apparatus 200 in accordance with the user command input to the OJ sensor 512. Hereinafter, referring to FIGS. 7 to 15, a method for controlling a display apparatus 200 according to a user command inputted to the OJ sensor 512 will be described.

If a rubbing interaction is inputted through the OJ sensor 512, the controller 540 may control the first communicator 521 to transmit a command for moving a highlight that is positioned on the icon in accordance with the direction of the rubbing interaction to the display apparatus 200.

In particular, as illustrated in FIG. 7, if a rubbing interaction to rub the OJ sensor 512 in the right direction is input in a state where a plurality of cubic GUIs 710 to 790 in the form of a cube are displayed on the display screen of the display apparatus 200 and a highlight is indicated on the fifth cubic GUI 750 among the plurality of cubic GUIs 710 to 790, the controller 540 may control the first communicator 521 to transmit a command for moving the highlight positioned on the fifth cubic GUI 750 to the right side and positioning the highlight on the seventh cubic GUI 770 to the display apparatus 200. Further, if a rubbing interaction to rub the OJ sensor in the left direction is input, the controller 540 may control the first communicator 521 to transmit a command for moving the highlight positioned on the fifth cubic GUI 750 to the left side and positioning the highlight on the second cubic GUI 720 to the display apparatus 200. Further, if a rubbing interaction to rub the OJ sensor in the diagonal direction on the upper left end is input, the controller 540 may control the first communicator 521 to transmit a command for successively moving the highlight positioned on the fifth cubic GUI 750 leftward and upward, and positioning the highlight on the first cubic GUI 710 to the display apparatus 200.

Further, if a push interaction is input to the OJ sensor 512, the controller 540 may determine whether the push interaction is an enter command or a trigger command to start determination of movement of the remote control device 50 through sensing the pressing time of the OJ sensor 512.

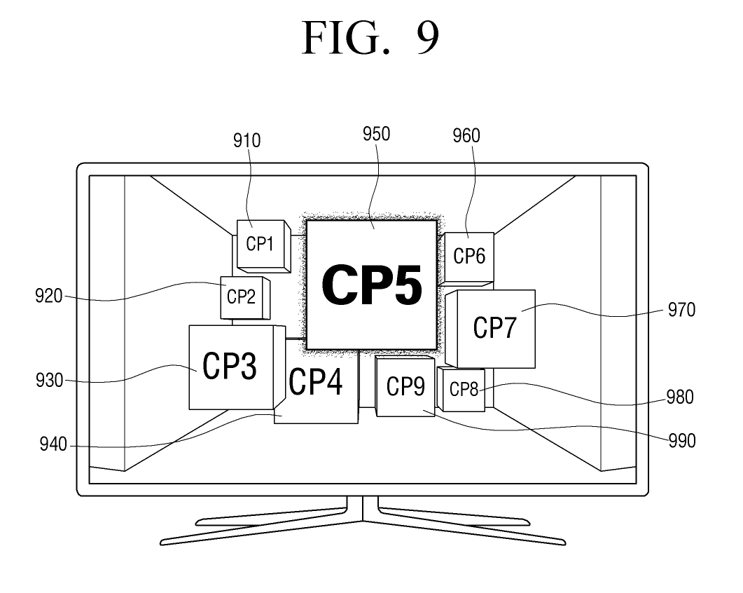

In particular, if the pressing time of the OJ sensor 512 is shorter than the predetermined time, the controller 540 may sense that the push interaction is the enter command, and may select an icon on which the highlight is positioned. For example, as illustrated in FIG. 9, if a push interaction to push the OJ sensor 512 for a time that is shorter than the predetermined time is inputted in a state where a plurality of cubic GUIs 910 to 990 in the form of a cube are displayed on the display screen and a highlight is displayed on the fifth cubic GUI 950 among the plurality of cubic GUIs 910 to 990, the controller 540 may control the first communicator 521 to transmit a command for selecting the fifth cubic GUI 950 and providing detailed information on the fifth cubic GUI 950 or providing a broadcasting image corresponding to the fifth cubic GUI 950 to the display apparatus 200.

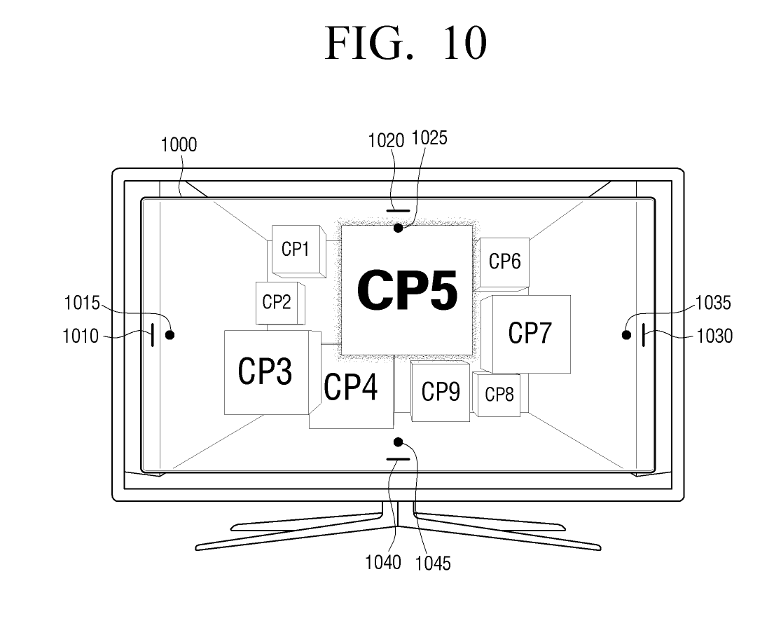

Further, if the pressing time of the OJ sensor 512 is longer than the predetermined time, the controller 540 may sense that the push interaction is the trigger command, and may start the sensing of the movement of the remote control device 50 using the 9-axis sensor 513. In particular, as illustrated in FIG. 9, if the pressing time of the OJ sensor 512 is longer than the predetermined time in a state where the plurality of cubic GUIs 910 to 990 in the form of a cube are displayed on the display screen, the controller 540 may control the first communicator 521 to transmit a command for displaying a UI 1000 for displaying the degree of movement of the remote control device 50 to the display apparatus 200 (as shown in FIG. 10). In this case, the UI 1000, as shown in FIG. 10, includes first indicators 1015, 1025, 1035, and 1045 for indicating the movement of the remote control device 50 in upper, lower, left, and right directions and second indicators 1010, 1020, 1030, and 1040 for indicating the movement threshold value of the remote control device 50.

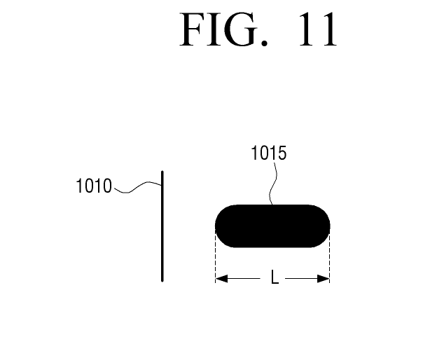

In particular, the first indicators 1015, 1025, 1035, and 1045 may change the length L according to the movement of the remote control device 50. For example, as shown in FIG. 11, if the remote control device 50 moves to the left side after the trigger command is inputted, the first indicator 1015 that corresponds to the movement of the remote control device 50 among the plurality of first indicators 1015, 1025, 1035, and 1045 may change the length L according to the movement of the remote control device 50 that moves in the left direction.

In particular, if the first indicators 1015, 1025, 1035, and 1045 move according to the movement of the remote control device 50 and come in contact with the second indicators 1010, 1020, 1030, and 1040, the controller 540 may control the first communicator 521 to transmit a command for changing the screen of the display apparatus 200 according to the moving direction of the remote control device 50 to the display apparatus 200.

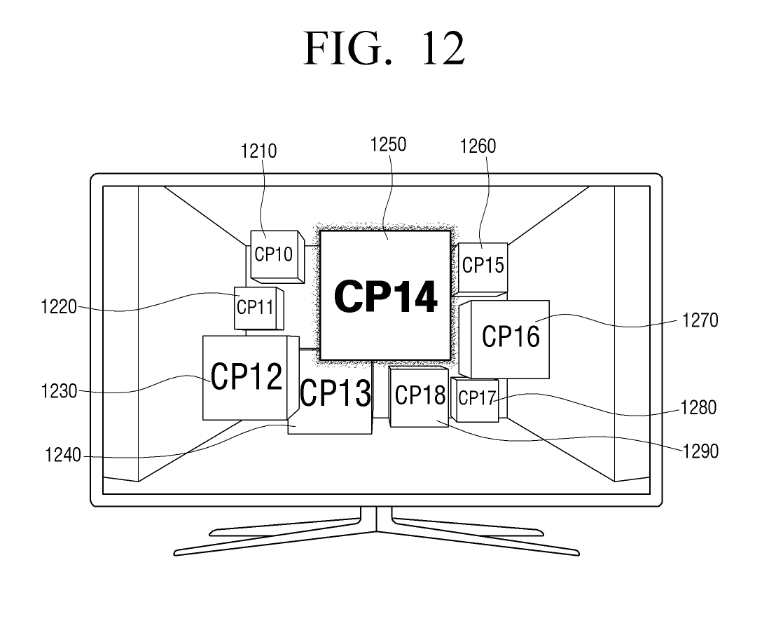

In an exemplary embodiment, if the trigger command is input while the display apparatus 200 displays the display screen (as shown in FIG. 9), the controller 540 may control the first communicator 521 to transmit a command for displaying the UI 1000 as illustrated in FIG. 10 to the display apparatus 200. Further, if the remote control device 50 moves in the left direction, the controller 540 may control the first communicator 521 to transmit a command for the first indicator 1015 to increase the length in the left direction to the display apparatus 200. Further, if the first indicator 1015 increases the length thereof according to the movement of the remote control device 50 and comes in contact with the second indicator 1010, the controller 540 may control the first communicator 521 to transmit a command for changing the screen of the display apparatus 200 in the left direction to the display apparatus 200. The display apparatus 200, in response to the command for changing the display screen in the left direction, may change the screen to the left side (as illustrated in FIG. 12) to display a plurality of new cubic GUIs 1210 to 1290.

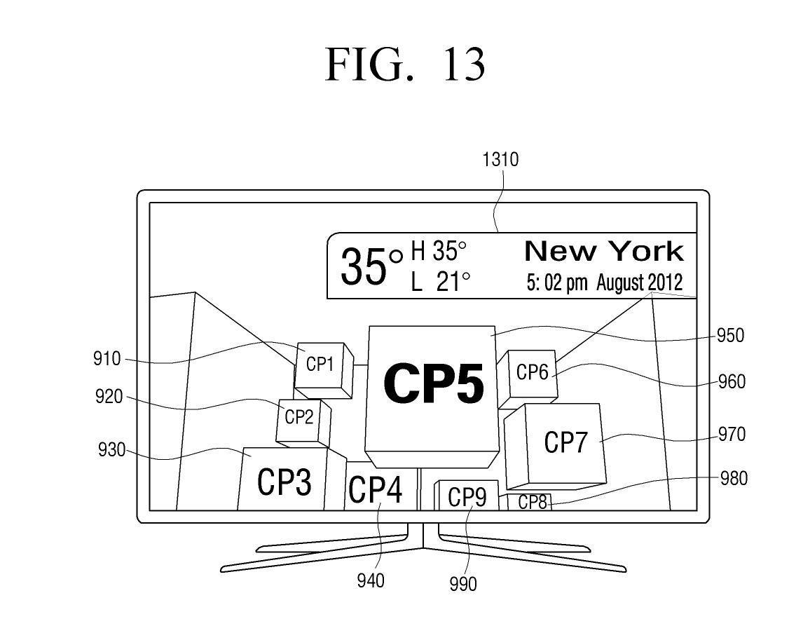

In another exemplary embodiment, if the trigger command is inputted while the display apparatus 200 displays the display screen (as shown in FIG. 9), the controller 540 may control the first communicator 521 to transmit a command for displaying the UI 1000 as illustrated in FIG. 10 to the display apparatus 200. Further, if the remote control device 50 moves in the upper direction, the controller 540 may control the first communicator 521 to transmit a command for the first indicator 1025 to increase the length in the upper direction to the display apparatus 200. Further, if the first indicator 1025 increases the length thereof according to the movement of the remote control device 50 and comes in contact with the second indicator 1020, the controller 540 may control the first communicator 521 to transmit a command for changing the screen of the display apparatus 200 in the upper direction to the display apparatus 200. The display apparatus 200, in response to the command for changing the display screen in the upper direction, may change the screen to the upper side (as illustrated in FIG. 13) to display a UI 1310 for providing weather information. However, the weather information where is displayed on the upper side of the screen is merely exemplary, and other rich site summary (RSS) information, such as stock information or latest news information, may be displayed.

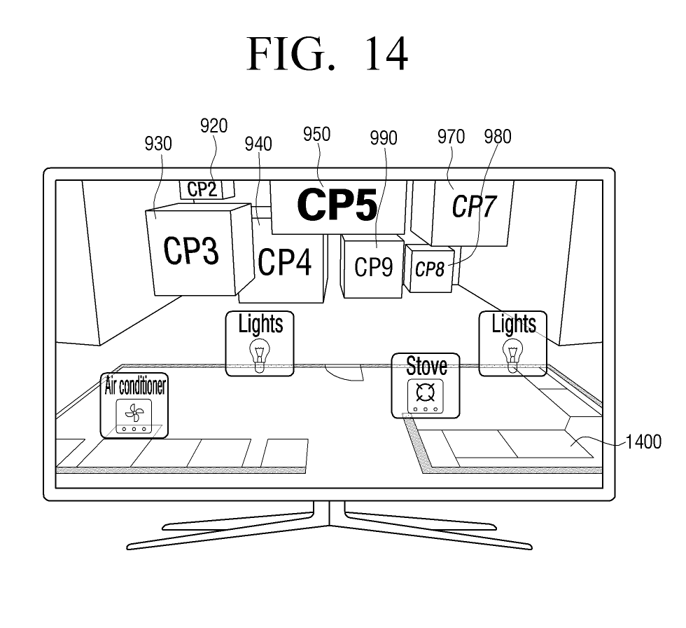

In still another exemplary embodiment, if the trigger command is input while the display apparatus 200 displays the display screen as shown in FIG. 9, the controller 540 may control the first communicator 521 to transmit a command for displaying the UI 1000 as illustrated in FIG. 10 to the display apparatus 200. Further, if the remote control device 50 moves in the lower direction, the controller 540 may control the first communicator 521 to transmit a command for the first indicator 1045 to increase the length in the lower direction to the display apparatus 200. Further, if the first indicator 1045 increases the length thereof according to the movement of the remote control device 50 and comes in contact with the second indicator 1040, the controller 540 may control the first communicator 521 to transmit a command for changing the screen of the display apparatus 200 in the lower direction to the display apparatus 200. The display apparatus 200, in response to the command for changing the display screen in the lower direction, may change the screen to the lower side (as illustrated in FIG. 14) to display a UI 1400 for controlling a home network device.

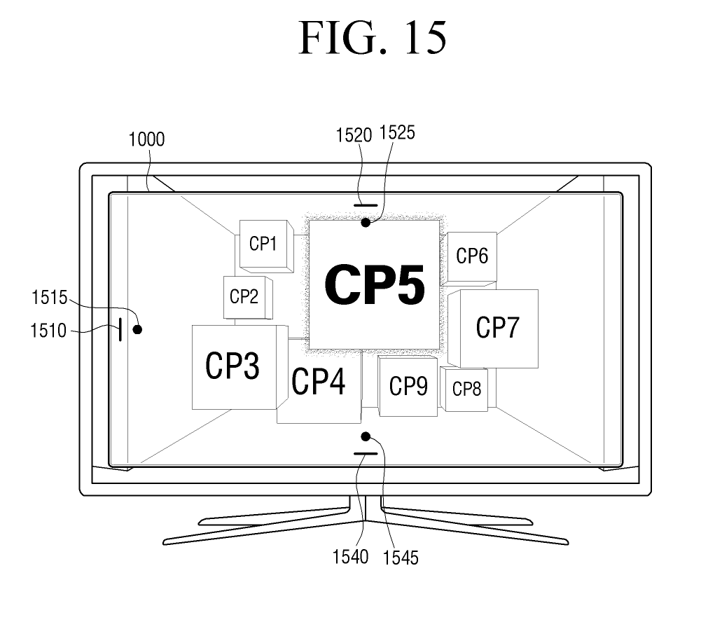

On the other hand, in the above-described exemplary embodiment, the first indicators 1015, 1025, 1035, and 1045 and the second indicators 1010, 1020, 1030, and 1040 are displayed in the upper, lower, left, and right directions of the UI. However, this is merely exemplary, and the UI may display only the first indicator and the second indicator in the direction in which the screen change is possible. For example, if it is possible to change the screen only in the upper, lower, and left directions, the display apparatus 200 may display the first indicators 1515, 1525, and 1535 and the second indicators 1510, 1520, and 1530 only in the upper, lower, and left directions (as illustrated in FIG. 15).

As described above, by simultaneously performing the enter command and the trigger command through one configuration, such as the OJ sensor, the number of buttons of the remote control device 50 can be reduced. Further, by displaying the indicator corresponding to the movement of the remote control device 50, the user can perform the screen change operation more easily and conveniently.

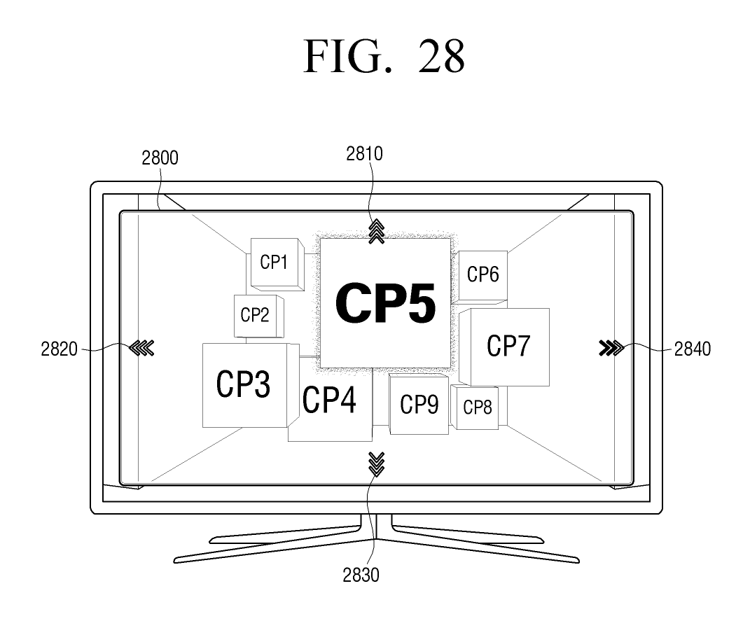

On the other hand, in the above-described exemplary embodiment, it is described that the indicators corresponding to the movement of the remote control device 50 are the first indicators 1015, 1025, 1035, and 1045 and the second indicators 1010, 1020, 1030, and 1040 (as illustrated in FIG. 10). However, this is merely exemplary, and other indicators may indicate the movement of the remote control device 50. For example, as illustrated in FIG. 28, indicators 2810, 2820, 2830, and 2840 in the form of a plurality of arrows may be displayed in the upper, lower, left, and right directions on the display screen. In this case, the arrows of the indicators 2810, 2820, 2830, and 2840 may be filled with colors according to the movement of the remote control device 50. For example, if the remote control device 50 moves to the right side, the indicator 2840 in the form of an arrow that is positioned on the right side may be gradually filled with color in the right direction. If the indicator 2840 in the form of an arrow that is positioned on the right side is completely filled with color according to the movement of the remote control device 50, the display apparatus 200 may change the current screen to the screen that is positioned on the right side.

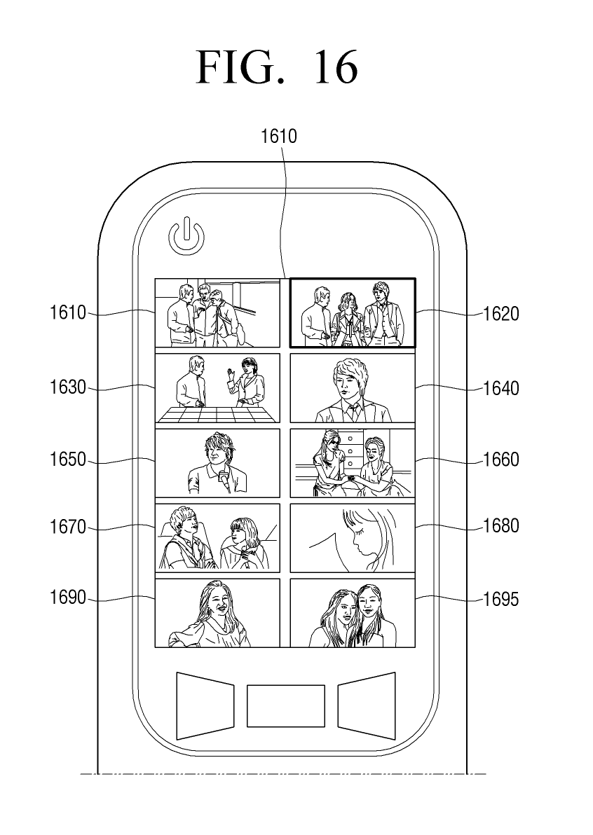

Further, if a bookmark interaction for selecting a bookmark button 511-7 is input, the controller 540 may provide a bookmark service for providing information related to an image or an object that is currently displayed on the display apparatus 200. Hereinafter, referring to FIGS. 16 to 24, a display apparatus 200 that provides a bookmark function will be described.

First, when the display apparatus 200 receives a broadcasting image, it may temporarily store the received broadcasting image in a buffer for a predetermined time while displaying the received broadcasting image. For example, the display apparatus 200 may temporarily store the received broadcasting image for 10 seconds.

If a bookmark interaction for selection the bookmark button 511-7 is input while the display apparatus 200 displays the received broadcasting image, the controller 540 may control the first communicator 521 to transmit a signal for requesting the image that is currently displayed on the display apparatus 200.

If the display apparatus 200 transmits the image to the remote control device 50 in response to the signal for requesting the currently display image, the controller 540 may control the display 530 to display the image received from the display apparatus 200. In particular, when the remote control device 50 transmits the signal for requesting the image that is displayed on the display apparatus 200, the display apparatus 200 may transmit a plurality of image frames that are temporarily stored in the storage 250 in relation to the currently display image to the remote control device 50. At this time, the display apparatus 200 may transmit the image frame to the remote control device 50 with a predetermined interval among image frames, from a predetermined previous point of time before the signal for requesting the image is received from the remote control device 50 to a point of time when the signal for requesting the image is received. For example, the display apparatus 200 can transmit 10 image frames to the remote control device 50 with an interval of 1 second from 9 seconds before the point of time when the signal for requesting the image is received from the remote control device 50 to the point of time when the signal for requesting the image is received from the image frames. At this time, the display apparatus 200 may transmit not only the image frames with the predetermined interval but also metadata including the information on the image frame. The metadata may include information on a character or person included in the image frame, information on a commodity or product (e.g., shopping information) included in the image frame, and information on the currently received broadcasting image. If 10 image frames are received, as illustrated in FIG. 16, the controller 540 may display the 10 image frames 1610 to 1695. In another exemplary embodiment, the predetermined interval may include a point of time from when the bookmark interaction is input to a point of time after the bookmark interaction is input. Further, the predetermined interval may include a period of time before the bookmark interaction is input to a same period of time after the bookmark interaction is input.

According to the user command, the controller 540 may provide the information related to the image that is currently displayed on the display apparatus 200. In this case, the information related to the image may be information that is retrieved by combining the object which is selected in the display 530 and a GUI element which is provided from the user interface 510.

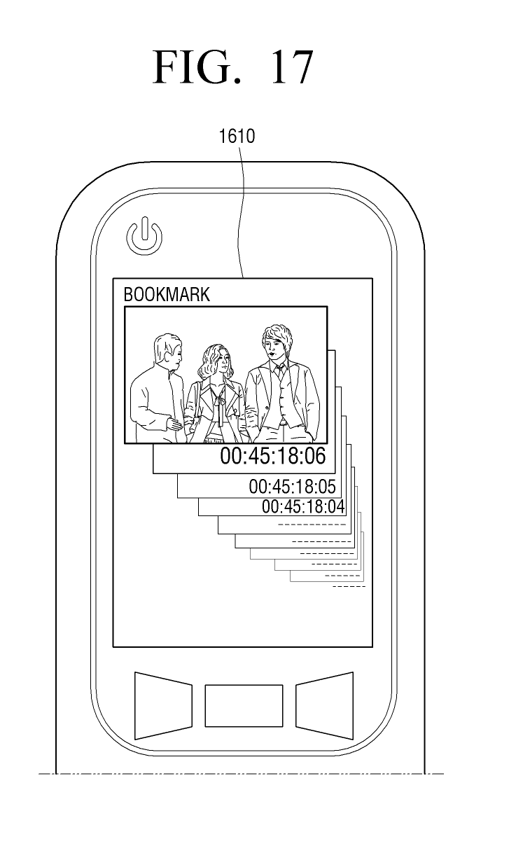

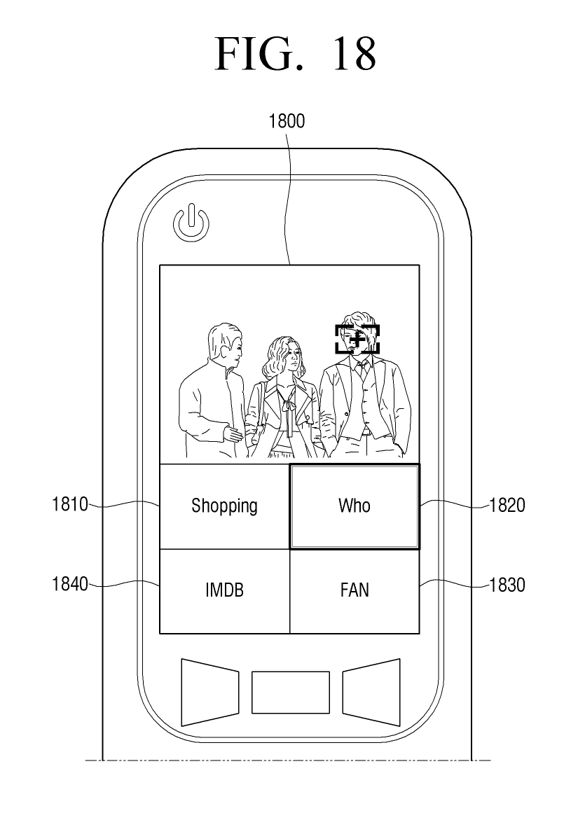

In particular, as illustrated in FIG. 16, if a user command for selecting a second image frame 1620 while 10 image frames 1610 to 1695 are displayed, the controller 540, as illustrated in FIG. 17, may control the display 530 to enlarge the selected image frame and to display the information on the selected image frame (e.g., reproduction time information). Further, if a pointer 1800 is positioned on the object to be retrieved in the selected image frame (as illustrated in FIG. 18) according to the user command (e.g., touch command), the controller 540 may control the display 530 to display a retrieval GUI for retrieving various information.

In this case, the retrieval GUI may include a “shopping” icon 1810 for providing shopping information of an article included in the selected image frame, a “who” icon 1820 for providing information on a character included in the selected image frame, a “fan” icon 1830 for providing other photo content of the character included in the selected frame, and an “IMDB” icon 1840 for providing detailed information on the image content included in the selected image frame.

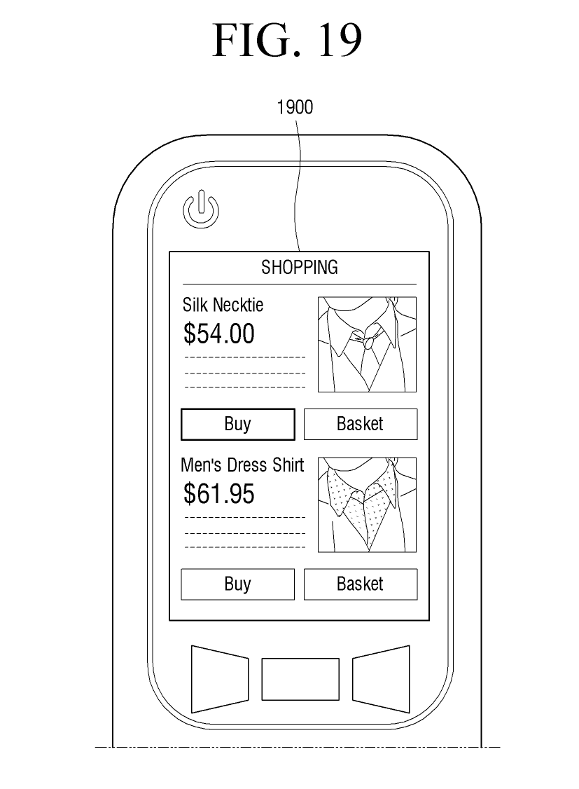

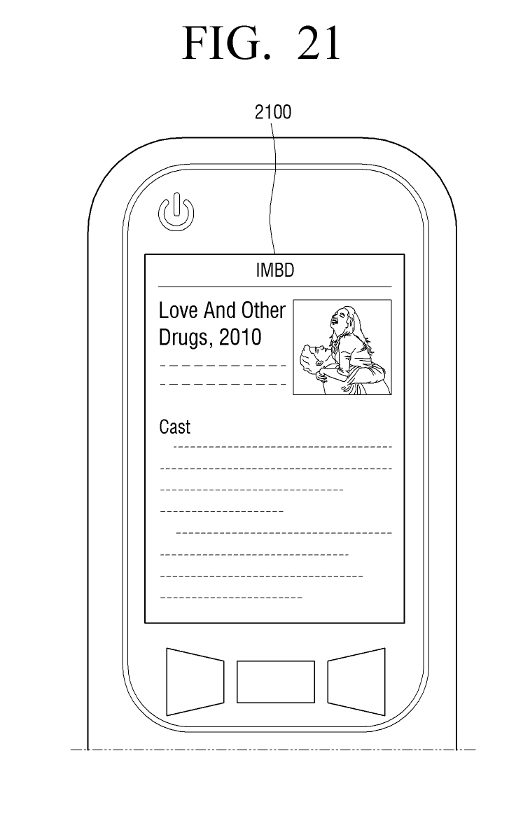

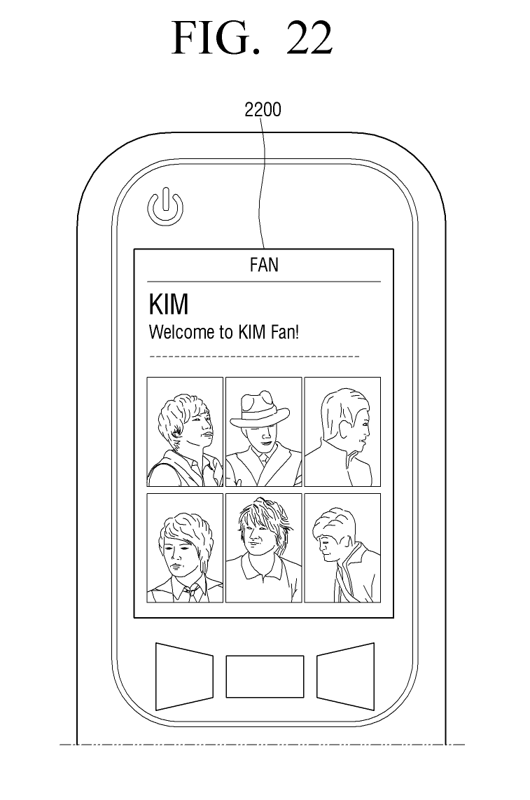

If one of the plurality of icons 1810 to 1840 included in the retrieval GUI is selected, the controller 540 may control the second communicator 522 to transmit a signal for requesting information which corresponds to the selected icon to the information retrieval server 300. Further, if the information related to the currently displayed image is received from the information retrieval server 300, the controller 540 may control the display 530 to display the information related to the received image. In particular, if the “shopping” icon 1810 for providing shopping information of the article included in the selected image frame among the plurality of icons is selected, the controller 540 may control the second communicator 522 to extract the information on the selected article (e.g., product name) from the metadata and to transmit the extracted information on the article to the information providing server 300 to request the shopping information on the article selected from the image frame. Further, if the shopping information on the article (e.g., the lowest price information) is received from the information providing server 300, the controller 540 may control the display 530 to display a UI 1900 including the received shopping information (as shown in FIG. 19). On the other hand, if the “who” icon 1820 for providing the information on the character included in the selected image frame is selected, the controller 540 may control the second communicator 522 to extract the information on the selected character (e.g., name of the character) from the metadata and to transmit the extracted information on the character to the information providing server 300. Further, if the information on the character (e.g., short history or other appearances of the character) is received from the information providing server 300, the controller 540 may control the display 530 to display a UI 2000 including the received information of the character (as shown in FIG. 20). Further, if the who icon 1820 for providing the information on the character included in the selected image frame is selected, the controller 540 may control the second communicator 522 to extract the information on the selected character (e.g., name of the character) from the metadata, and to transmit the extracted information on the character to the information providing server 300. Further, if the IMDB icon 1840 for providing the detailed information on the image content including the selected image frame is selected, the controller 540 may control the second communicator 522 to extract the information on the image (e.g., title of the image) from the metadata and to transmit the extracted information on the image to the information providing server 300. Further, if the detailed information on the image (e.g., a plot of the image, reproduction information, and appearing actor/actress) is received from the information providing server 300, the controller 540 may control the display 530 to display a UI 2100 including the received detailed information on the image (as shown in FIG. 21). Further, if the fan icon 1830 for providing other photo content of the character included in the selected image frame is selected, the controller 540 may control the second communicator 522 to extract the information on the selected character (e.g., name of the character) from the metadata and to transmit the extracted information on the character to the information providing server 300. Further, if another photo of the selected character is received from the information providing server 300, the controller 540 may control the display 530 to display a UI 2200 including another received photo (as shown in FIG. 22).

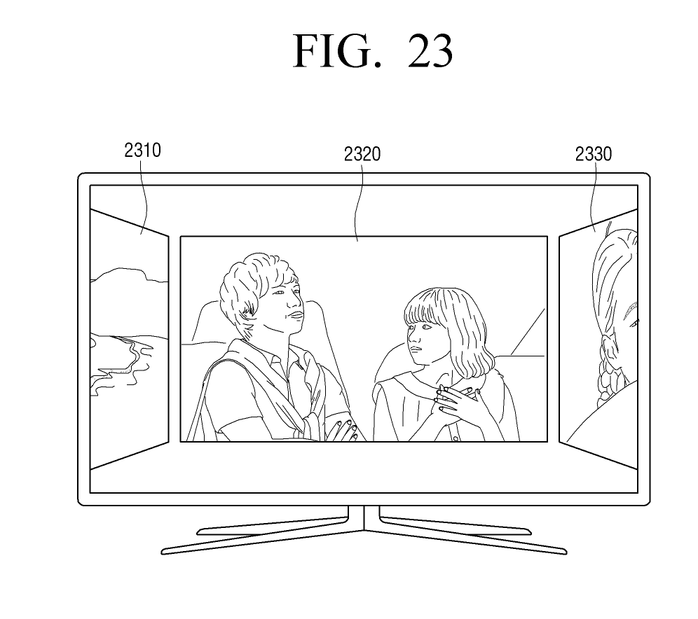

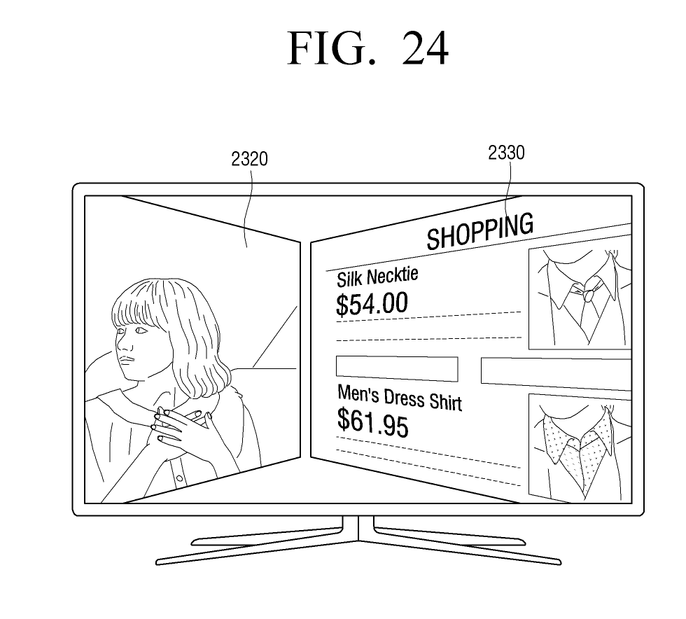

Further, the controller 240 may control the first communicator 521 to display the information related to the image that is currently displayed on the display 530 on the display screen of the display apparatus 200 according to a predetermined user interaction. In particular, if a third screen designation button 511-11 that corresponds to the second sub-screen among the screen designation buttons of the remote control device 50 is selected while the shopping information as illustrated in FIG. 19 is displayed on the display 530, the controller 540 may control the first communication unit 521 to transmit the command for displaying the shopping information on the second sub-screen to the display apparatus 200. If the display apparatus 200 receives the command for displaying the shopping information on the second sub-screen, as illustrated in FIG. 23, the display apparatus 200 displays a main screen 2320 and a plurality of sub-screens 2310 and 2330. Then, the display apparatus 200 may move the main screen 2320 and the plurality of sub-screens 2310 and 2330 to the left side. Further, as illustrated in FIG. 24, the display apparatus 200 may display the image on the main screen 232 of the display screen, and may display the shopping information related to the image on the second sub-screen 2330. In another exemplary embodiment, the shopping information related to the image and the image may be displayed on the main screen 232.

As described above, by providing information related to an image to one of a plurality of screens of the remote control device 50 or the display apparatus 200, the user can confirm the information related to the image more easily without disturbing the viewing of the image being currently displayed.

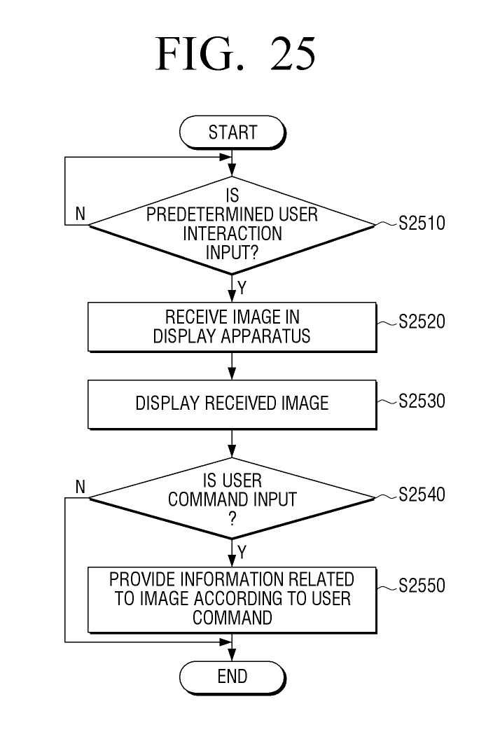

Hereinafter, referring to FIGS. 25 to 27, various embodiments will be described.

FIG. 25 is a flowchart illustrating a method for controlling a remote control device 50 for providing a bookmark service according to an exemplary embodiment.

First, the remote control device 50 determines whether a predetermined user interaction is input (S2510). At this time, the predetermined user interaction may be a bookmark interaction for selecting a bookmark button 511-7 among buttons provided on the remote control device 50.

If the predetermined user interaction is input (S2510-Y), the remote control device 50 receives an image from the display apparatus (S2520). In particular, if the bookmark interaction is input, the remote control device 50 may transmit a signal for requesting the image to the display apparatus 100. If the display apparatus 100 transmits the currently displayed image to the remote control device 50 in response to the signal for requesting the image, the remote control device 50 may receive the image which is currently displayed on the display apparatus 100 from the display apparatus 100. At this time, the remote control device 50 may receive the image frame from the display apparatus 100 with a predetermined interval, among image frames that are displayed by the display apparatus 100, from a predetermined previous point of time before the bookmark interaction is input to a point of time when the bookmark interaction is inputted. In another exemplary embodiment, the predetermined interval may include a point of time from when the bookmark interaction is input to a point of time after the bookmark interaction is input. Further, the predetermined interval may include a period of time before the bookmark interaction is input to a same period of time after the bookmark interaction is input.

Further, the remote control device 50 displays the received image frame (S2530). In particular, as shown in FIG. 17, the remote control device 50 may display the plurality of image frames received.

Then, the remote control device 50 determines whether a user command for receiving the information related to the image is input (S2540). At this time, the user command may be a user command for selecting one of the plurality of image frames or a user command for selection the information to be retrieved.

If the user command is input (S2540-Y), the remote control device 50 provides the information related to the image according to the user command (S2550). In particular, if the user command is input, the remote control device 50 may provide information related to the pre-stored image or may provide information related to the image received from the external information providing server 300. In this case, the remote control device 50 may display shopping information, character information, and detailed information of the image as the information related to the image.

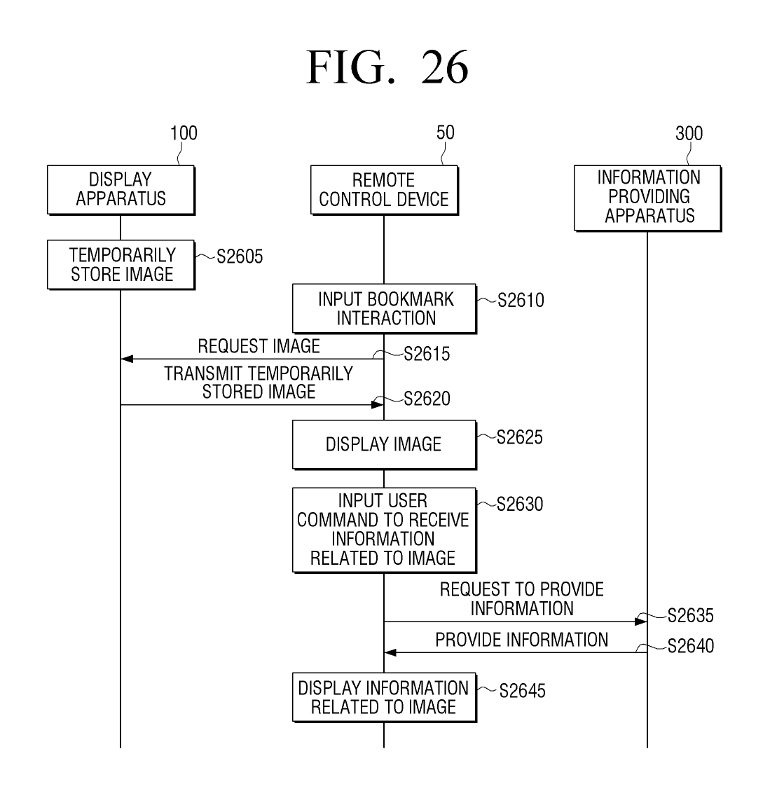

FIG. 26 is a sequential diagram explaining a method for controlling a display system 10 for providing a bookmark service according to an exemplary embodiment.

First, the display apparatus 100 temporarily stores the received image (S2605). In particular, the display apparatus may temporarily store the currently received broadcasting image in a FIFO method for a predetermined time (e.g., 10 seconds). In this case, the display apparatus 100 may temporarily store all the image frames for the predetermined time. However, this is merely exemplary, and the display apparatus may temporarily store the image frame (e.g., I frame) with the predetermined interval, among the image frames, for the predetermined time.

Then, the remote control device 50 receives a bookmark interaction from a user (S2610). In this case, the bookmark interaction may be a user interaction for selecting a bookmark button, among a plurality of bookmark buttons provided in the remote control device 50.

Then the remote control device 50 requests an image from the display apparatus 100 (S2615).

The display apparatus 100, in response to the image request, transmits the temporarily stored image to the remote control device 50 (S2620). In particular, the display apparatus 100 may transmit the temporarily stored image frame with the predetermined interval to the remote control device 50.

Then, the remote control device 50 displays the image received from the display apparatus 100 (S2625). At this time, the remote control device 50 may display all the image frames with the predetermined interval.

Then, the remote control device 50 receives a user command for receiving the information related to the image (S2630). In this case, the user command for receiving the information related to the image may include a user command for selecting one of image frames with the predetermined interval, a user command for selecting a target to be retrieved among the selected image frames, and a user command for selecting the kind of information to be retrieved among the information on the selected target.

Then, the remote control device 50 requests information from the information providing server 300 (S2635). In particular, the remote control device 50 may request the information on the target selected by the user. In this case, the kind of information may include at least one of information on a character included in the selected image frame, information on other photo content of the character included in the selected image frame, shopping information on an article included in the selected image frame, and detailed information on the image content including the selected image frame.

Then, the information providing server 300 provides information to the remote control device 50 in response to the information providing request (S2640).

Then, the remote control device 50 displays the information related to the image received from the information providing server 300 (S2645). Further, the remote control device 50 may transmit the information related to the image to the display apparatus 100 according to the user command so that the information related to the image can be displayed on the display apparatus 100.

As described above, since the remote control device 50 provides the information related to the image, the user can confirm the information related to the image through the remote control device 50 while viewing the image through the display apparatus 100.

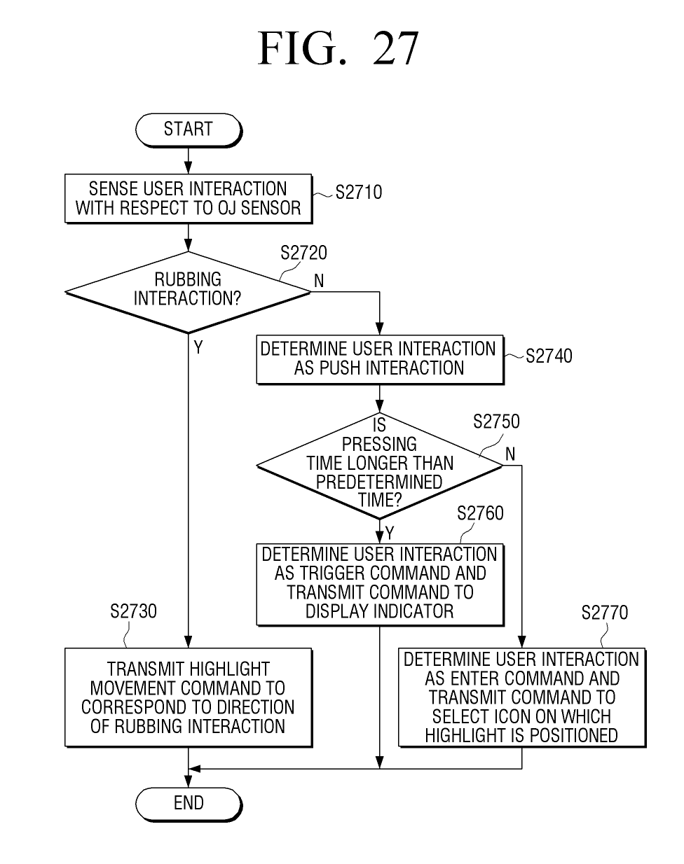

FIG. 27 is a flowchart illustrating a method for controlling the display apparatus 100 according to a user interaction input to an OJ sensor through the remote control device 50.

First, the remote control device 50 senses the user input with respect to the OJ sensor (S2710).

Then, the remote control device 50 determines whether the user interaction input to the OJ sensor is a rubbing interaction to rub the OJ sensor (S2720).

If it is determined that the user interaction is the rubbing interaction (S2720-Y), the remote control device 50 transmits a highlight movement command to the display apparatus 100 to correspond to the direction of the rubbing interaction (S2730). Therefore, the display apparatus 100 may move the currently displayed highlight to another icon to display the highlight on the corresponding icon.

If it is determined that the user interaction is not the rubbing interaction (S2720-N), the remote control device 50 determines that the input user interaction is a push interaction (S2740).

If it is determined that the user interaction is the push interaction, the remote control device 50 determines whether the pressing time of the OJ sensor by the user is longer than a predetermined time (S2750).

If the pressing time of the OJ sensor by the user is longer than the predetermined time (S2750-Y), the remote control device 50 determines that the push interaction is a trigger command, and transmits a command for displaying an indicator to the display apparatus 100 (S2760). At this time, the trigger command may be a command for starting movement sensing of the remote control device 50. If a command for displaying the indicator is received, the display apparatus 100 may display the indicator for guiding the movement of the remote control device 50.

However, if the pressing time of the OJ sensor is shorter than the predetermined time (S2750-N), the remote control device 50 determines that the push interaction is an enter command, and transmits a command for selecting an icon on which the highlight is positioned to the display apparatus 100 (S2770). Therefore, the display apparatus 100 selects the icon on which the highlight is positioned, and may display the detailed information of the image corresponding to the icon or reproduce the image corresponding to the icon on the display screen.

As described above, by receiving various user commands using one OJ sensor, the number of buttons provided on the remote control device 50 can be reduced, and the user usability can be improved.

According to another exemplary embodiment, the remote control device 50 may perform a second TV function in which the display apparatus 100 receives in real time an image from the display apparatus 100 and displays the received image. In this case, if the bookmark interaction is input while the remote control device 50 receives the image in real time that is displayed on the display apparatus 100, the remote control device 50 may store the bookmark information on the scene at a time when the bookmark interaction is inputted. If a predetermined user command is input later, the remote control device 50 may reproduce the image again from the time when the bookmark interaction is input using the pre-stored bookmark information, or may transmit a command for reproducing the image again from the time when the bookmark interaction is input to the external display apparatus 100.

Further, the remote control device 50 may detect a scene that includes a predetermined object (e.g., a player) and provide an auto bookmark function to store the information on the detected scene. In particular, if a specific actor/actress is selected by a user, the remote control device 50 may detect whether the specific actor/actress selected by the user is present in the image using a face recognition technique, etc. If the specific actor/actress selected by the user is detected, the remote control device 50 may store the bookmark information on the scene from which the specific actor/actress selected by the user is detected. If the predetermined user command is input, the remote control device 50 may reproduce the image again from the scene from which the specific actor/actress is detected using the pre-stored bookmark information, or may transmit a command for reproducing the image again from the scene from which the specific actor/actress is detected to the external display apparatus 100.

The case where the remote control device 50 recognizes the object and automatically stores the bookmark information is merely exemplary. The bookmark information can be automatically stored through detection of various factors, such as the specific scene, specific behavior of an actor/actress, atmosphere of the screen, sound, and music.

On the other hand, the control method according to various embodiments as described above may be implemented by a program and may be stored in a non-transitory computer readable medium. The non-transitory computer readable medium is not a medium that stores data for a short period, such as a register, a cache, or a storage, but means a medium which semi-permanently stores data and is readable by a device. In particular, various applications and programs as described above may be stored and provided in the non-transitory computer readable medium, such as, a CD, a DVD, a hard disc, a Blu-ray disc, a USB, a storage card, and a ROM.

While the present disclosure has been shown and described with reference to certain embodiments thereof, it will be understood by those skilled in the art that various changes in form and detail may be made therein without departing from the spirit and scope of the exemplary embodiments, as defined by the appended claims.

What is claimed is:

1. A remote control device for controlling a display apparatus, the remote control device comprising:
a user interface configured to receive a user interaction;
a first communicator configured to communicate with the display apparatus and receive an image;
a display; and
a controller configured to, in response to a first interaction being input through the user interface, control the display to display at least one image of a plurality of images received from the display apparatus, and in response to an object included in the at least one displayed image being selected according to a second interaction input through the user interface and a graphic user interface (GUI) element being selected through the user interface, retrieve information related to the selected object, and display the information related to the selected object.

2. The remote control device as claimed in claim 1, wherein in response to the first interaction being input through the user interface, the controller is configured to control the first communicator to receive a plurality of image frames, which are displayed by the display apparatus, with a predetermined interval from a predetermined previous point of time before the first interaction is input to a point of time when the first interaction is input.

3. The remote control device as claimed in claim 2, wherein the controller is configured to control the display to display the received image frames with the predetermined interval on the display, and in response to one of the displayed image frames with the predetermined interval being selected, display the GUI for selecting the information related to the selected object included in the selected image frame.

4. The remote control device as claimed in claim 3, wherein the GUI element comprises at least one of an icon for providing information on a character or a person included in the selected image frame, an icon for providing different photo content of the character or the person included in the selected image frame, an icon for providing information on a product included in the selected image frame, and an icon for providing information on image content including the selected image frame.

5. The remote control device as claimed in claim 1, further comprising:
a second communicator configured to communicate with an external server,
wherein the controller is configured to, in response to the object included in the at least one displayed image being selected according to the second interaction, control the second communicator to receive the information related to the selected object from the external server.

6. The remote control device as claimed in claim 5, wherein the controller is configured to control the first communicator to receive metadata of the image together with the image, and control the second communicator to transmit the metadata to the external server and receive information on the metadata from the external server.

7. The remote control device as claimed in claim 1, wherein the controller is configured to control the first communicator to transmit the information related to the selected object to the display apparatus, and
wherein the display apparatus is configured to display the information related to the selected object.

8. The remote control device as claimed in claim 7, wherein in response to the information related to the object being received from the remote control device, the display apparatus is configured to generate a plurality of screens, display the image on one screen of the plurality of screens, and display the information related to the selected object on another screen of the plurality of screens.

9. A method for controlling a display apparatus of a remote control device, the method comprising:
in response to a first interaction being input in a user interface, displaying at least one image from among a plurality of images received from the display apparatus; and
in response to an object included in the at least one displayed image being selected according to a second interaction input in the user interface and a graphic user interface (GUI) element being selected through the user interface, retrieving and displaying information related to the selected object,

10. The method as claimed in claim 9, wherein in response to the first interaction being input, the displaying the at least one image comprises receiving a plurality of image frames, which are displayed by the display apparatus, with a predetermined interval from a predetermined previous point of time before the first interaction is input to a point of time when the first interaction is input.

11. The method as claimed in claim 10, wherein the displaying the at least one image further comprises displaying the received image frames with the predetermined interval, and
wherein the retrieving and displaying the information related to the selected object comprises, in response to one of the displayed image frames with the predetermined interval being selected, displaying the GUI for selecting the information related to the selected object included in the selected image frame.

12. The method as claimed in claim 11, wherein the GUI element comprises at least one of an icon for providing information on a character or person included in the selected image frame, an icon for providing different photo content for the character or the person included in the selected image frame, an icon for providing information on a product included in the selected image frame, and an icon for providing information on image content including the selected image frame.

13. The method as claimed in claim 9, wherein the retrieving and displaying the information related to the selected object comprises, in response to the object included in the at least one displayed image being selected according to the second interaction, receiving the information related to the selected object from an external server.

14. The method as claimed in claim 13, wherein the receiving information related to the selected object comprises receiving metadata of the image together with the image, and
wherein the retrieving and displaying the information related to the selected object further comprises transmitting the metadata to the external server and receiving information on the metadata from the external server.

15. The method as claimed in claim 9 further comprising:
transmitting information related to the selected object to the display apparatus,
wherein the display apparatus displays the information related to the selected object.

16. The method as claimed in claim 15, wherein in response to the information related to the object being received from the remote control device, the display apparatus generates a plurality of screens, displays the image on one screen of the plurality of screens, and displays the information related to the selected object on another screen of the plurality of screens.

17. A display apparatus comprising:
a communicator configured to communicate with a remote control device;
a display;
a storage; and
a controller configured to temporarily store in the storage an image which is displayed by the display, and in response to a predetermined command being input from the remote control device, control the communicator to transmit the image which is temporarily stored in the storage to the remote control device.

18. The display apparatus as claimed in claim 17, wherein the controller is configured to, in response to the information related to the image being received from the remote control device, control the display to display a plurality of screens on the display, display the image on one screen of the plurality of screens, and display information related to the image on another screen of the plurality of screens.

19. A method for controlling a display apparatus, the method comprising:
displaying an image;
storing the displayed image in a storage temporarily; and
in response to a predetermined command being input from a remote control device, transmitting the image which is temporarily stored in the storage to the remote control device.

20. The method as claimed in claim 19 further comprising:
in response to the information related to the image being received from the remote control device, displaying a plurality of screens on the display, displaying the image on one screen of the plurality of screens, and displaying information related to the image on another screen of the plurality of screens.

21. A method of controlling a remote control device configured to control a display device, the method comprising:
determining whether a predetermined user interaction is input;
receiving an image from the display apparatus in response to the predetermined user interaction being input;
displaying the received image on a display of the remote control device;
determining whether a user command is input; and
displaying information related to the received image in response to the user command being input.

22. The method as claimed in claim 21, wherein the predetermined user interaction is a bookmark interaction input through a button of the remote control device.

23. The method as claimed in claim 22, wherein the image from the display apparatus is an image frame with a predetermined interval from a predetermined previous point of time before the predetermined user interaction is input to a point of time when the bookmark interaction is input.

24. The method as claimed in claim 21, wherein the user command is a command for selecting at least one of a plurality of image frames of the image.

25. The method as claimed in claim 21, wherein the user command is a command for selecting the information related to the received image.

26. The method as claimed in claim 21, wherein the information related to the received image displayed by the remote control device is retrieved from an external server.
